(19) United States
(12) Patent Application Publication
(10) Pub. No.: US 2016/0286156 A1
(43) Pub. Date: Sep. 29, 2016

(54) SYSTEM FOR MANAGING INFORMATION RELATED TO RECORDINGS FROM VIDEO/AUDIO RECORDING DEVICES

(71) Applicant: Creative Law Enforcement Resources, Inc., South Pasadena, CA (US)

(72) Inventor: Kresimir Kovac, Fountain Valley, CA (US)

(21) Appl. No.: 15/179,649

(22) Filed: Jun. 10, 2016

Related U.S. Application Data
(63) Continuation-in-part of application No. 14/620,748, filed on Feb. 12, 2015.
(60) Provisional application No. 62/175,189, filed on Jun. 12, 2015.

(51) Int. Cl. H04N 5/77; G08B 6/00; G06K 9/00; H04N 5/232; H04N 5/907; G06Q 50/26; G11B 27/36; F41C 33/02; G06F 17/30; H04W 4/02; H04L 29/08; H04N 5/28; G11B 27/10

(52) U.S. Cl. CPC H04N 5/772; H04N 5/28; G08B 6/00; G06K 9/00744; H04N 5/23245; H04N 5/907; G11B 27/10; G11B 27/36; F41C 33/029; G06F 17/3082; H04W 4/021; H04L 67/18; G06Q 50/26

(57) ABSTRACT

A system and related software for effectively utilizing law enforcement resources is provided. The system includes a recording device configured to continuously record audio and/or video, thereby providing an audio and/or video recording, a computing device associated with the recording device, the computing device configured to receive a trigger indication and upon receiving the trigger indication establish a prior point in time of the audio and/or video recording as a beginning of a critical event and preserve recorded audio and/or video from the beginning of the critical event to an end recording point, and a remote device configured to analyze audio and/or video recordings including the preserved audio and/or video and provide information based on audio and/or video recording analysis. At least one of the computing device and the remote device is configured to apply information to the recorded audio and/or video based on events occurring between the beginning of the critical event and the end recording point for analysis by the remote device.

This application is a continuation-in-part of U.S. patent application Ser. No. 14/620,748, entitled “Belt System for Use with Video/Audio Recording Devices,” inventor Kresimir Kovac, filed Feb. 12, 2015, and claims priority based on U.S. Patent Application Ser. No. 62/175,189, entitled “System for Managing Information Related to Recordings from Video/Audio Recording Devices,” inventor Kresimir Kovac, filed Jun. 12, 2015, both of which are incorporated herein by reference in their entireties.

### BACKGROUND

I. Field

The present disclosure relates generally to the field of recording devices, and more particularly to software and systems for managing and analyzing information in various official scenarios, such as law enforcement or military scenarios, to improve outcomes using prediction, including situations wherein officials employ recording devices while performing their duties.

II. Background

Many government jurisdictions are currently deploying camera systems for use by law enforcement personnel, including police officers. Such systems are also being provided to correctional officers, military, security guards or other personnel, generally referred to herein as “officers.” The goal in using these recording devices is to obtain evidence of encounters with the public during an officer's shift for use in subsequent criminal and/or civil proceedings.

Two primary methods have been utilized to record the actions of police officers: In-Car-Video Systems and manually activated personal recording devices. Numerous agencies have installed In-Car-Video recording systems in vehicles. These systems tend to be extremely expensive and are only effective if the activity of interest occurs within range of the police vehicle's camera and audio recording device. Additionally, significant issues can result due to maintenance and repair of fleet vehicles housing these systems.

A second method of recording law enforcement activities is to issue small audio or video recording devices to individual officers. Such camera systems are frequently body mounted, i.e. affixed to the officer's person, such as clipped to a shirt around his or her chest area, and the camera systems capture video images during various law enforcement situations. Camera systems have also been employed by military personnel in some capacity, including but not limited to helmet mounted cameras and the like. Such camera systems need to be durable and operational during critical times in particular, but can conceivably be operated at all times when an officer is on duty. A variety of potential issues arise when law enforcement personnel employ body-mounted camera devices in the field, including the potential failure of an officer to activate the camera during a critical incident, the operational failure of the camera, or the camera device capturing images not intended for public view.

Virtually all camera devices available to law enforcement personnel offer an “on/off” type switch so the officer can turn the camera recording device on and off. Because the switch enables officers to activate the device at will only during critical incidents, the memory source may not reach capacity as quickly, however, this limitation may be problematic in the field. Critical incidents are dynamic and often sudden and surprising, requiring immediate attention and full focus of the officer. In such event, an officer may be unable to activate the recording device for several seconds or minutes, failing to record the critical aspects of the incident. Officers may forget to turn on their camera recording devices for many reasons, including rapid escalation of routine contacts, injury to the officer, temporary disablement of the officer, or even simple preoccupation or inattention. In certain high stress situations it can be difficult or virtually impossible for any person to remember to turn on a recording device. Additionally, law enforcement personnel are trained to react to a threat first and then conduct administrative actions later once their safety has been assured. For example, if a suspect shoots a firearm at an officer, the officer is trained to draw and return fire as rapidly as possible in order to save his/her own life. The officer should preferably not be attempting turn on a video recording device prior to drawing their weapon and returning fire.

An officer may wear a body worn recording device capable of transmitting video images to a remote location having larger storage capacity, such as a law enforcement vehicle nearby, or to a device on the officer's person. The equipment carried by military or law enforcement personnel must be limited in size and weight, and requiring an officer to carry a data storage device in addition to a video recording device is excessive. Alternately, a Wi-Fi, Bluetooth or cellular (commercial wireless) system may be used to transmit video images to a central location, such as a police station or other facility via an intermediate booster or transmitter located in a nearby vehicle or via a cellular tower. Problems with this arrangement include signal interruption and security. When the officer is in a location wherein such signals cannot be successfully transmitted to the nearby receiver, such as in an underground location or far from the officer's station or squad car, the signal will not be received and video images will be lost. Further, such signals may be intercepted by parties who should not have access to the images. While signal transmission security measures may help with interception issues, even minor signal losses during critical situations are unacceptable, therefore making most wireless image transmission solutions generally undesirable.

While conceptually it may be preferable to record every action of a law enforcement officer, in reality recording everything can be undesirable in a number of situations regularly encountered by law enforcement or the military. An officer whose video recording device is constantly recording may inadvertently record private citizens' confidential information. An example where this is a concern is the practice that has become known as “swatting,” where a person calls the police to say that someone is committing a crime at the residence of a famous person, the caller occasionally purporting to be the famous person. In this situation, law enforcement is summoned to the famous person's private residence. If law enforcement is recording the entire incident, he or she may record private information inside the famous person's residence. With the public having the ability to submit Freedom of Information Act (FOIA) requests to obtain public records, the “swatting” caller or even someone who heard about the “swatting” call could potentially seek to obtain the video images recorded during the “swatting” and, if successful, obtain personal and private information about the interior of the famous person's home, including contents, layout, and so forth. The same may be said of an officer recording any confidential information of any private citizen. Other mundane events, such as use of restrooms and personal conversations between officers, should not be recorded.

From a technical perspective, constant video recording throughout an eight to sixteen hour shift can create a situation where numerous batteries will be required to power the device, a significant amount of time will be needed to transmit recorded video to video storage servers, resulting in exorbitant costs to store massive amounts of video data and significant administrative management issues for the large amounts of video generated by an enterprise level law enforcement agency. Constant recording of video footage by law enforcement personnel, or in other words the inability to turn off video image recording, is therefore a significant potential problem.

A number of devices are available that incorporate a camera designed to be carried on the body of a law enforcement officer. These cameras include, but are not limited to combination cameras attached to Taser devices (sold by Taser International, Inc.), cameras incorporated into flashlights, cameras provided with firearms, and so forth. The problem with all of these is the same as described above, the inability to record what happened before the Taser, firearm, flashlight, etc. was deployed, and worse than a body mounted camera, these devices must be deployed and engaged to record the incident. In some instances the scenario can unnecessarily escalate. For example, a belligerent suspect may become violent if a gun barrel with a camera is pointed at him, albeit merely to record the situation. Also, if the officer needs to use his or her weapon but must also pull out, for example, a flashlight with an attached camera in order to record an event, such requirements are undesirably cumbersome and in many cases will not be achieved. In such critical scenarios, it is likely that officers will fail to effectively deploy equipment, including the recording device.

A further issue with such devices is the ability to catalog, archive, and locate the information recorded. With the development of wearable technology, dedicated software is needed to manage recorded and/or live video/audio and related metadata captured by these systems. Additionally, software is needed to manage and integrate ancillary and peripheral systems and information.

Most current police body worn camera (BWC) systems utilize dedicated BWC's which are purpose built to record video with little capability for tagging, cataloging, and the like. These systems typically generate video/audio recordings with minimal collection of data such as date, time, GPS location, activation time, etc. As more advanced systems are developed and utilized, the quantity of information and metadata collected increases, thereby creating the need for integration.

Current technology allows for limited pieces of information to be added to audio/video recordings as metadata after the incident has concluded. This manual tagging can not only be significantly delayed, but is susceptible to inaccuracies and human error. The manual entry of critical information creates a situation in which information may not be consistent as it is not automatic, which dramatically increases administrative workload in that there is a requirement for immediate review and determination of which data to add. Additionally, as the number of devices fielded increases, the number of hours required for manual review and tagging also increases. Manual entry of information often creates variances in databases, making queries and reporting functionality inaccurate and inefficient.

Video analytic software is limited in its applicability with body worn cameras. Video analytics utilize specific algorithms to identify patterns and deviations from those patterns thereby triggering an alert or flagging an event. Video analytics are most effective when deployed in a fixed environment with a constant (unchanging background). This provides a control baseline for the video analytic software to compare new events. Utilizing video analytics with body worn cameras can be fraught with inaccurate information and false positive alerts. With body cameras, the background is constantly changing with the movement of the officer, lighting conditions are less than ideal and often change and the officer and other recorded parties are typically moving. Compounding this problem is the fact that audio/video quality of the body worn cameras is frequently poor due to the limited size of the camera optics and lack of integrated lighting in the camera. These circumstances create an extremely difficult environment for video analytics software to process and automatically identify key events without an unacceptable number of false positive alerts. In terms of database and video analytics, the information gleaned from the collection of data is only as good as the data collected. Expecting software to improve recorded video and associated data after the recording of such data so that the data and information can be considered reliable creates significant issues in terms of the veracity of the information.

Some existing body worn camera technology enables the adding of metadata to recorded incidents after the fact. This method, however, is extremely time intensive, requiring review of each video and manual entry of appropriate information. The adding of the metadata may be significantly delayed, if not forgotten, thereby creating inconsistencies across recorded incidents and disabling effective tracking and pattern identification. Metadata may not be added for days or weeks after the incident, when the circumstances and particulars are no longer fresh and therefore less reliable.

Due to the limited amount of metadata collected and recorded in current BWC systems, reports and analysis of data are constrained. An organization such as a police agency will generally utilize multiple BWCs assigned to various officers on a given date throughout a large geographic region. Each officer may record several hours of video/audio on each BWC on each shift. Since current BWCs allow for limited metadata, the ability to generate detailed reports and analysis of the use of BWCs on a level encompassing all persons on a given day is limited. Additionally, limited amounts of metadata make analyzing patterns and/or predicting behavior impractical or impossible.

It would be highly beneficial to offer a system wherein the issues related to video and audio recording by individuals such as law enforcement, military and security personnel are minimized or eliminated. An intuitive system that is activated in critical incidents without specific thought or intention on behalf of the officer, and one that does not require significant additional equipment to be carried or maintained would be desirable. Further, a system that enables accurate record keeping with the data (video and audio) generated from such a system may also be beneficial. Additionally, such a system would be beneficial if it would have the capability to generate reports and analyze data based on the real time actions of officers, the public, and significant occurrences in society.

### SUMMARY

According to the present design, there is provided a system for effectively utilizing law enforcement resources. The system includes a recording device configured to continuously record audio and/or video, thereby providing an audio and/or video recording, a computing device associated with the recording device, the computing device configured to receive a trigger indication and upon receiving the trigger indication establish a prior point in time of the audio and/or video recording as a beginning of a critical event and preserve recorded audio and/or video from the beginning of the critical event to an end recording point, and a remote device configured to analyze audio and/or video recordings including the preserved audio and/or video and provide information based on audio and/or video recording analysis. At least one of the computing device and the remote device is configured to apply information to the recorded audio and/or video based on events occurring between the beginning of the critical event and the end recording point for analysis by the remote device.

According to an alternate version of the present design, there is provided a system for deploying law enforcement resources, comprising a recording device configured to continuously record audio and/or video, thereby providing an audio and/or video recording, a computing device associated with the recording device, the computing device configured to establish a prior point in time of the audio and/or video recording as a beginning of a critical event and preserve recorded audio and/or video from the beginning of the critical event to an end recording point, and a remote device configured to analyze audio and/or video recordings including the preserved audio and/or video and provide information based on audio and/or video recording analysis. The computing device is configured to sense a trigger indication using multiple sensing means and issue a command to the recording device upon sensing the trigger indication.

According to a further aspect of the present design, there is provided a system for deploying law enforcement resources, comprising a recording device configured to continuously record audio and/or video, thereby providing an audio and/or video recording, a computing device configured to transmit a trigger indication signal to the recording device to commence recording and receive the audio and/or video recording by establishing a prior point in time of the audio and/or video recording as a beginning of a critical event and preserve recorded audio and/or video from the beginning of the critical event to an end recording point, and a remote device configured to analyze the preserved audio and/or video and provide information based on audio and/or video recording analysis. The computing device is configured to sense a trigger indication using multiple sensing means and transmit the trigger indication signal to the recording device upon sensing the trigger indication.

Various aspects and features of the disclosure are described in further detail below.

### BRIEF DESCRIPTION OF THE DRAWINGS

FIG. 1 shows an example of an existing police belt or officer's belt, including devices and receptacles;

FIG. 2 is a conceptual representation of the present system;

FIGS. 3A, 3B, 3C, and 3D show recording representations in various scenarios using the processing/recording device of the present design;

FIG. 4 shows tape having flat wires provided therewith that may be employed with the present design;

FIG. 5 illustrates interconnections using the tape including wires between various belt receptacles and the processing/recording device;

FIG. 6 is a representation of the processing/recording device;

FIG. 7 illustrates operation of the present design in conjunction with various modes of communication;

FIG. 8 generally represents the overall system including the flow of information and data to the various devices and locations deployed in the field; and

FIG. 9 is a general flowchart of the operation of the present design.

### DETAILED DESCRIPTION

The present design enables law enforcement, military, security officers or other appropriate personnel to automatically record (audio and/or video) evidence, within their presence, without the need to manually or consciously initiate the recording, such as during situations where the individual is under stress. The recording system has the ability to automatically preserve video/audio images of the officer's actions from a time prior to occurrence of a critical event at times when he/she is in the performance of his/her duties as an officer.

Further, the present design includes is a system that operates in connection with the belt system and camera to enable management of critical data captured by devices which capture or record information. The present system flags and records information as dictated by key events, predefined triggers or identified thresholds. Such data is related to incidents recorded by audio/video recording or other devices, thereby creating the capability for predictive management of personnel wearing the recording device as well as more effective analysis of trends and other information. Additionally, the present design provides for real time situation management through its ability to automatically push live audio/video to remote facilities such as data or crime centers.

Included in the present design is a capability of integrating existing BWC video/audio and data into the system. Additionally, other sources of video/audio, data, etc. may be integrated into the system to provide additional data and metrics which may be used to augment analysis reports and predictive analysis of relevant and/or predefined occurrences.

The system may also be used to augment or replace operating software in existing and proposed BWC designs. The system would then enhance metadata and recording capabilities of existing future BWC systems.

According to the present design, the remote device analyzes video/audio, metadata and other sources of information and has the capability of generating comprehensive reports. Such functionality may be provided as hardware, software, or otherwise. The remote device is configured to analyze numerous items of data provided by the system as well as outside sources. This analysis provides a baseline of and for identifying actions, occurrences, behaviors, etc. The remote device is configured to provide predictive analysis flags and alerts based on deviations from identified patterns and predefined standards identified in the system.

Belt System

The belt acts as the backbone for a holistic system in which cameras, activation mechanisms, monitoring systems, recording devices, GPS, commercial wireless, Wi-Fi, etc. are integrated into an electronic device capable of managing the system, recording audio/video, transmitting/receiving/storing data among other capabilities.

As used herein, various terms are employed and are intended to be used in the broadest sense possible. For example, the present application uses the term “officer” or “law enforcement officer” or otherwise to indicate the individual employing the system, and such a term is meant to broadly encompass any individual who may have use for such a device or system, including but not limited to police officers, military personnel, corrections officers, security personnel, or other interested individuals. Additionally, contents of the belt described herein may differ, and different officers may employ different equipment. The officer may employ a holster that holds a handgun, a receptacle for a baton, handcuffs, radio, OC spray, a light source such as a flashlight, and a control device, but any type of appropriate item, such as an item utilized by law enforcement, security, or military officers may be employed. Different devices may be used to record video and/or audio images, and/or store and transmit these video/audio images. With respect to recording devices, the term “camera device” is intended broadly to mean any type of recording device, typically a video and audio recording body mounted device, a video only body mounted device, or an audio device. These are collectively referred to herein as a “recording device.” Further, certain devices are described herein as being a single device while others are described as multiple devices, and it is to be understood that the invention is not limited to the devices described but single or multiple devices may be employed where multiple and single devices, respectively, are described, as long as the functionality described is performed. The foregoing and other concepts disclosed herein are intended to be interpreted broadly and not limit the scope of the present invention.

A prominent part of the present design is a variation of a standard police duty belt currently worn by virtually every police officer on duty in the United States. The police duty belt is worn around the waist of the law enforcement officer over a secondary inner belt, typically looped through the belt loops of the officer's pants. The duty belt contains various pouches and holsters which secure various items of police equipment to the officer's waist. This equipment includes but is not limited to a handgun, ammunition, a police radio, a police baton, OC spray, handcuffs, a recording device, a flashlight, and in certain instances other types of devices. Generally, the pouches and holsters on the outer police duty belt are attached and not removed unless the officer wishes to modify their contents or provide a pouch or holster with a different function.

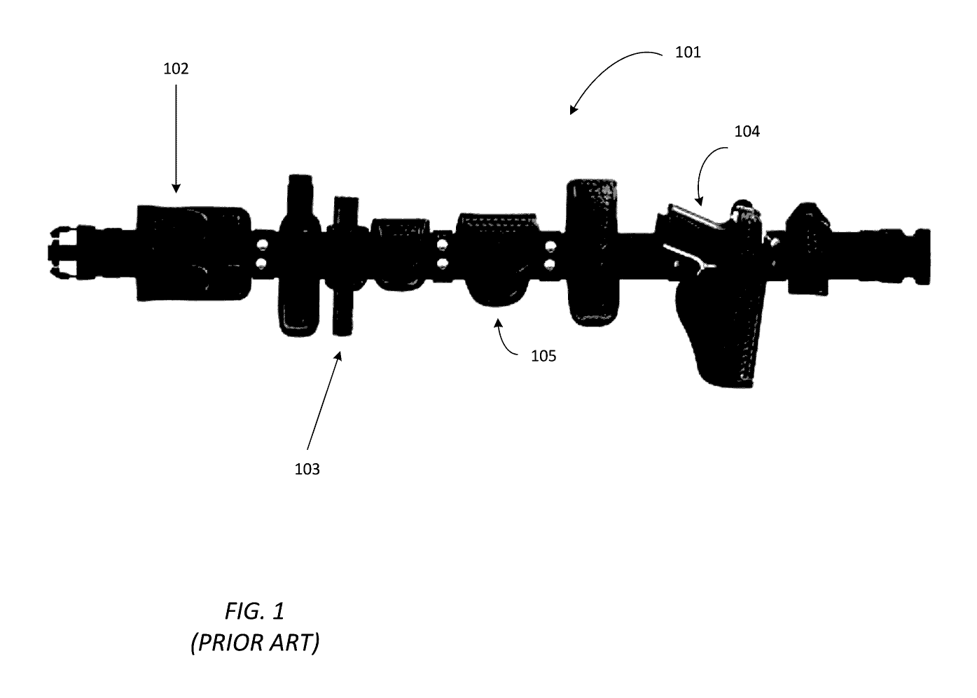

FIG. 1 illustrates one example of a standard police belt. Other devices may be adapted in accordance with the present design to operate in conjunction with a recording device as disclosed herein. Each of the above listed items is secured in a holster or pouch which is firmly attached, via a belt loop, to the outer duty belt or belt 101. Each pouch or holster typically utilizes a metal snap closure attached to a synthetic flap to secure the item inside the pouch. This flap or snap is generally part of some type of security retention system designed to securely hold the item of equipment on the belt until the officer deploys the item.

In order to remove an item from a pouch or holster, the officer must first unsnap the security flap, snap, strap, clasp or other retention system in order to remove the item. An example would be an officer unsnapping the retention strap on his/her handgun holster prior to drawing the firearm. The duty belt 101 may be constructed of different materials, including one or more layers of leather, with leather pouches or holsters. Other materials may be employed, such as nylon, plastic, Kydex, laminates, etc., and belts may be constructed of more than one type of primary material.

FIG. 1 illustrates various official devices and receptacles used in one instance of a duty belt 101, with devices including ammunition 102, flashlight 103, handgun 104, and handcuffs 105. The present system provides an interface between the duty belt 101 and the various pouches and holsters on the belt which enclose an assortment of items and equipment. This interface electronically connects a recording device to the duty belt and the various pouches and holsters provided with the duty belt. When an officer intends to deploy an item of equipment, he/she first unsnaps the security flap/retention system of the pouch holding the item. This unsnapping action is a signal, called herein a “critical event signal” or “critical event indication,” indicating the recording device should initiate with no further action required from the officer. In the belt arrangement shown in FIG. 1, the officer's gear (handgun, electroshock weapon, OC Spray, baton, etc.) is secured and cannot be deployed without first unsnapping the retention snap. The present design employs this attribute, i.e. unsnapping the retention snap is a critical event signal or indication causing the recording device arrangement to function in a desired manner and preserve desired video and/or audio. As a result, a video/audio recording is initiated as the officer makes the decision to deploy a handgun, baton, OC spray or handcuffs, or other desired belt component or holstered device, without the separate activation of the recording device. Other actions can be considered a critical event signal as described herein. Additionally, there may some equipment carried in a pouch or device with no retention system (such as a baton). In such a case, a mechanism may be provided in or with the pouch that activates the recording device once the equipment is drawn or deployed. A simple switch or other method or means may be incorporated into the pouch or belt in order to accomplish this functionality.

The recording arrangement, such as a recording device and a storage device, is configured with a buffer or loop and the recording device is configured to continuously record audio and video and discard unmarked or unidentified audio or video. The audio recording can be considered a first in, first out buffer or circular buffer arrangement wherein portions are periodically discarded while new audio or video is recorded. Size of the buffer depends on the equipment employed, i.e. the size of the storage employed, quality of video or audio desired, administrative settings on the device, and decisions of appropriate personnel. As an example, a thirty second buffer, a five minute buffer, or a buffer of any other desired time period may be employed. Different buffer time standards may be provided depending on the item of equipment activating the recording device.

When, for example, an officer unsnaps his/her handgun holster, a critical event signal is sent to the recording device and the recording device marks the time of the indication and also marks the point a fixed time prior to the critical event signal and saves and does not discard video or audio obtained between the marked point (e.g. one minute before) and the critical event signal, i.e. the officer unsnapping his/her holster, and continues to record until the officer stops the device or the maximum recording time allowable is reached. While recording, the recording device may discard unnecessary, i.e. unmarked, recordings to increase capacity.

Thus each time a peace officer unsnaps the retention device to deploy an item of police equipment from his/her duty belt (or draws the equipment if there is no overt retention system), the incident and events during a period of time preceding the critical event signal, as well as the period of time immediately following activation of the recording device are captured on video/audio. Recording is initiated automatically in the course of normal officer duties and actions, without additional conscious thought or effort on part of the officer, and is typically limited to periods when the officer is engaged in significant police action or a critical event (i.e. arrest, use of force, officer involved shooting, etc.). As the officer and his/her employing agency are at the greatest liability risk during these critical incidents, such a recording of the incident has significant evidentiary value and can reduce this liability burden.

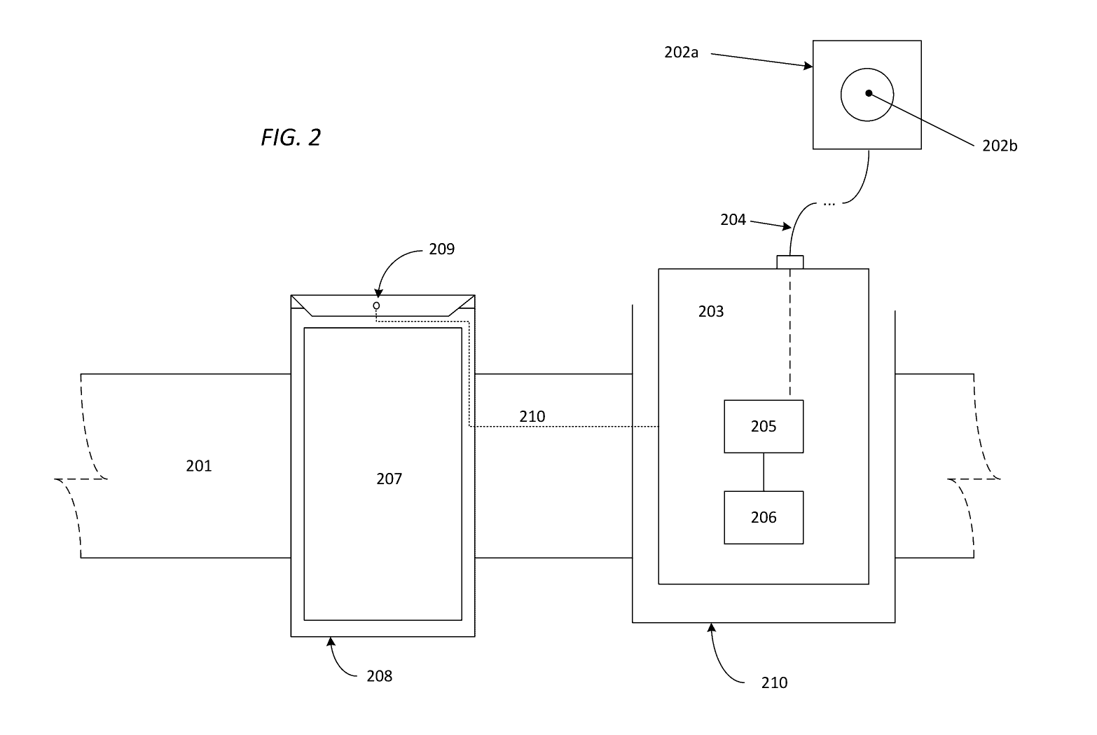

The present design is conceptually shown in FIG. 2. From FIG. 2, there is provided a police belt 201, a recording device 202a configured to be located on the officer's person and record video and/or audio images, including a sensor 202b in this embodiment. Signals are transmitted to a processing/storage device 203 such as by the wire 204 shown or wirelessly. Wireless transmission requires a transmitter connected to or provided with the recording device and a remote receiver connected to or providing signals to the processing/storage device 203 as described herein. Any of these components may be integrally formed in a single housing or may be separate components.

Processing/storage device 203, also representing a recording device, may include a processor 205, a storage device 206, and the processor 205 may be configured to perform the functions provided herein and other relevant functions. Processing/storage device 203 may be integrated into police belt 201 or may be provided separately with a separate storage compartment or holster provided on the police belt 201. Storage compartment/holster 211 is shown in this embodiment. Also shown in FIG. 2 is a holstered item 207, which may be a gun, for example, but any of the aforementioned devices, contained within a holster 208. Holster 208 includes a retention snap 209, and retention snap 209 is electrically connected in this embodiment to processing/storage device 203. A wireless connection or other appropriate connection may be provided at a point between retention snap 209 and processing/storage device 203. Electrical connection to retention snap 209 may be using any known means, including providing a small current through or voltage across the retention snap 209 such that the snap acts as a switch, providing a signal or value when closed and a different signal or value when open. Processing/storage device 203 may provide other functionality, such as monitoring noise levels to detect gunshots, and so forth. Although not shown in this view, one or both of processing/storage device 203 and recording device 202a may be provided with a switch (not shown) able to turn on and off recording of desired incidents.

While shown as a snap device, retention snap 209 may be any type of retention mechanism or means and may take other forms, such as a conductive strip or piece, a motion sensor in the holster 208, a light sensor in the holster 208 that senses a change in light received, such as when a holstered item is removed from the holster 208. Alternately, the design may include other means for establishing a critical event, such as a safety strip that operates so that removal of the holstered item 207 tears or otherwise compromises the strip, and compromise of the strip can be sensed indicating a critical event has occurred. Any other device or sensor or apparatus that can be used to determine the holster 208 has been opened and/or holstered item 207 has been removed may be employed.

When the system senses that holster 208 has been opened and/or holstered item 207 has been removed, an electrical signal is provided to processing/storage device 203, such as via line 210, and processing/storage device 203 senses the signal and determines that the holster 208 has been opened and/or holstered item 207 has been removed. Such an indication is a critical event signal, and upon sensing a critical event signal, processing/storage device 203 performs audio/video processing as described below.

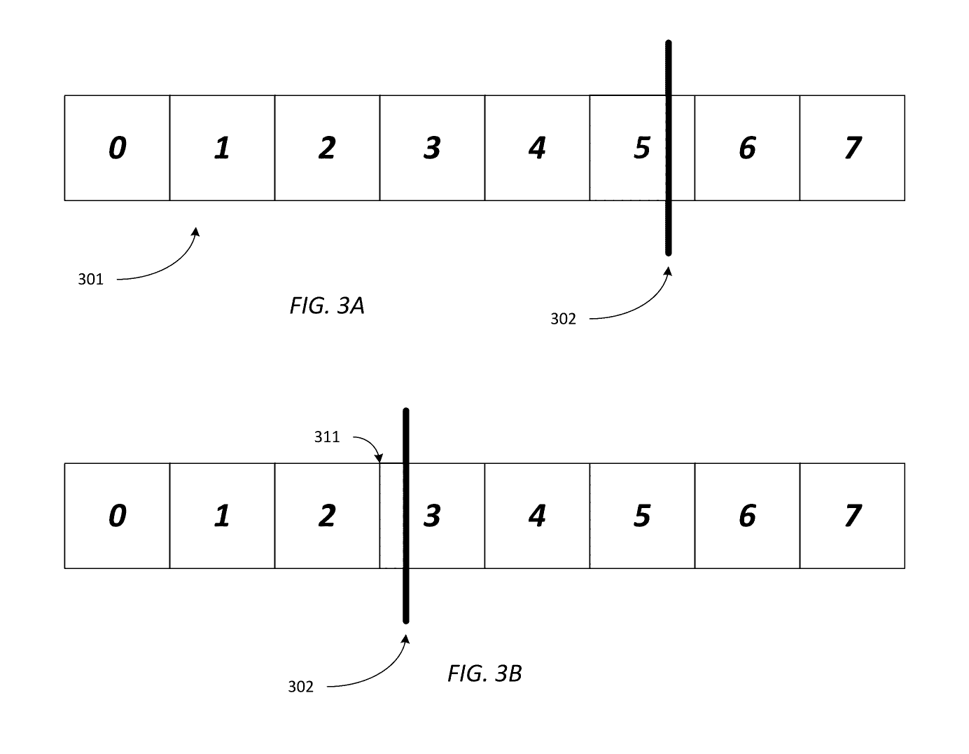

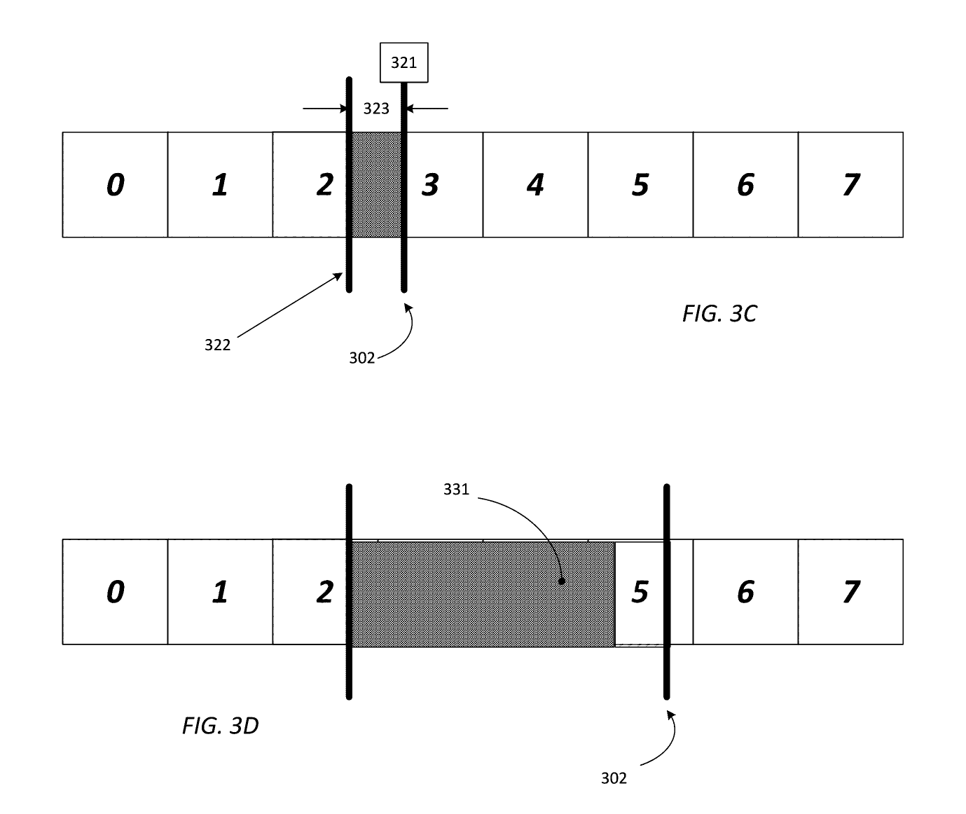

Various embodiments of critical event signal and buffer operation are illustrated in FIGS. 3A, 3B, 3C, and 3D. FIG. 3A shows the buffer 301 partially filled, where the recording device 202 and the processing/storage device 203 have been operating for a period of time, the period of time less than the time needed to completely fill the buffer 301. Buffer 301 in this view is divided into eight sections numbered 0 through 7. If the buffer 301 could accommodate one hour of combined video and audio recording, FIG. 3A illustrates less than one hour of recorded video and/or audio images, such as approximately 35 or 40 minutes in this embodiment. Other buffer sizes and region sizes may be provided. Present time 302 is shown, and buffer regions 0, 1, 2, 3 and 4 are full, while buffer regions 6 and 7 are empty. Buffer region 5 is partially full and partially empty.

FIG. 3B shows buffer 301 where the buffer 301 is again partially full, but the recording device 202 and the processing/storage device 203 have been operating for a period of time greater than the time needed to completely fill the buffer 301. In this embodiment, present time 302 is in buffer region 3, buffer region 4 is empty, and all other buffers are filled with previously recorded video and/or audio recordings. In one embodiment, the buffer cycles from buffer region 7 to buffer region 0 as current time progresses from buffer region 7 to a next buffer, i.e. the buffer 301 is circular or operates as a circular buffer. Other buffer designs may be employed. In this embodiment, when current time 302 passes a buffer region border, the system clears the next subsequent buffer region. In this example, when current time 302 passes buffer region 3 initial border 311, the system clears out buffer region 4. In this manner, one buffer region is emptied at the time the preceding buffer region begins to fill. Other implementations may be realized wherein space in buffer 301 is made available on a continuing basis and past video and/or audio data is maintained in an ongoing basis.

FIG. 3C illustrates system operation in the case of receipt of a critical event signal. Present time 302 is shown, and at present time 302 critical event signal 321 is received. Buffer region 4 is empty. Processing/storage device 203 identifies preceding time point 322 and marks preceding time point 322, where time period 323 represents a predetermined amount of time between receipt of the critical event signal and the desired beginning of the video and/or audio information to be saved. From that point until recording device is turned off and/or the processing/storage device 203 is turned off, such as by the officer, the processor/storage device 203 continues to record and store video and and/or audio.

As may be appreciated, certain issues can occur, including the storage filling up. Some interactions can last for lengthy periods of time, even hours. Additionally, in a fistfight or other scuffle, one of the devices in FIG. 2 can be disabled, broken, disconnected, or otherwise rendered ineffective. In the case of an extended or lengthy incident, the processing/storage device may provide a warning or may operate at a reduced fidelity, such that a lower quality video and/or audio record is maintained after a period of time to preserve as much evidence as possible. As an example, the processing/storage device 203 may switch to a low fidelity video recording mode when buffer 301 is 75% full. One method is to record video and audio every other second, or transitioning from X frames per second to 0.5× frames per second.

Again, recording continues until the officer turns off the recording such as via an included hardware or software switch. Once the recording has been turned off, after such an event, the officer may complete his shift and turn his or her device in for processing. Processing in this context includes downloading, transferring, or offloading the video and/or audio data to a central storage location or device. In other situations, if a large enough storage device is available, the officer may be able to record more than one critical event during a single shift. In this situation, the representation of FIG. 3C may include two or more critical event signals and two or more periods of time wherein the processing/storage device 203 is recording video and/or audio.

If enough recording time is available for the officer to continue performing his or her duties, one example of which is shown in FIG. 3D, the (first) incident 331 is preserved, recording resumes and is ongoing after the officer has ended incident 331, and recording proceeds in a loop bypassing instance 331. Critical event processing may occur as described above with accommodations made to not erase or “tape over” incident 331. Note that in any of these scenarios depicted in FIGS. 3A through 3D, the amount of available time may be provided to the officer, such as via display on a screen of the processing/storage device 203.

The present system may employ security features to inhibit tampering with the recordings by an officer. In one instance, an officer may employ excessive force and may fear discipline as a result of his or her use of excessive force. The officer may attempt to tamper with the recording of the incident, by taping over or otherwise destroying the video and/or audio of the incident. The present design may, for example, provide a marking (date and time), random number, or other indication whenever a critical incident occurs, such as an indication that is not displayed with or otherwise provided with the video footage and cannot be erased or altered except by a different (official) device or by using a particular code. Any other indicator that cannot be erased or deleted by the officer may be employed and/or provided. Additional security safeguards may be incorporated such as watermarks or other methods to identify and inhibit tampering of recorded evidence either on the recording device or once downloaded onto a storage system.

Thus the present design, and more particularly the processing/storage device 203, performs functions including but not limited to audio recording using a microphone, the recording buffer capability described above, a manual slide activation switch, automatic activation as described above, play, rewind and fast forward functions. Functions and buttons (hard or soft) may be provided to effectuate a file function, bookmark function, and/or folder function. An override off switch may be provided. A display screen and an activation indication, such as a light, may be provided, as well as an audio speaker plug and/or audio microphone plug. The unit may employ a rechargeable battery, removable media (e.g. SD card), and as noted information may be transferred or downloaded to a separate central drive or a removable drive such as a CD or DVD. The device may produce video and/or audio compatible with existing formats, e.g. Windows Media Player or QuickTime. The device may also utilize an affirmative notification feature in which a sound, light and/or vibration is used to notify the officer when the system is activated thereby ensuring the system never activates without the officers knowledge.

The processing/storage device 203 may also include digital video recording capability in the form of a separate video recording apparatus (miniature video camera). The system, including the recording device 202, may include a video camera incorporated into a standard police radio handset, a video camera clipped onto a radio handset, a video camera incorporated into the belt 201, and/or a video camera clipped onto the shirt, pocket or other part of the officer's uniform.

The system may utilize a camera incorporated into the processing/storage device 203 and a secondary external camera mounted somewhere on the officer's body. The system, when activated, may initiate both cameras simultaneously to provide different views of an incident or may only active one camera as predefined by the user/administrator. In such a case, the system could be set up to automatically turn on the second camera in the event the primary camera is disabled (e.g. fight, wires pulled from camera body, etc.). Thus the system may incorporate more than one video camera or more than one audio microphone. A camera may be incorporated into the body of the processor 203 or other device worn on the duty belt 201. A secondary camera may be attached on another part of the officer's body or belt system 201 to provide an opposing secondary view of an incident. Additionally, the integration of a secondary camera, connected via a wired or wireless method, would help ensure the recording is not completely disabled during a struggle/fight with a suspect whereby the primary camera is ripped from the device or disabled due to damage (e.g. blow, kick, crushed). The system may be configured so that only one camera is operational during normal recording activations; however, both cameras may be activated when a handgun or baton are deployed.

The processing/storage device 203 may include functionality such as acoustic gunshot activation and/or a directional acoustic gunshot detector. The processing/storage device 203 may employ a diagnostics/self-test feature, a built-in external speaker, a built-in playback screen, an external/plug-in microphone, an On/Off switch to shut off all recorder functions, and/or a lockable recorder memory medium access door. The system may employ RFID devices implanted in pouches and holsters, and a police car mobile digital computer (MDC) may interface with the processing/storage device 203. RFID, WiFi, Bluetooth or other wireless connectivity may be provided between the present system and a police vehicle and/or a police radio.

A vibratory feature may be provided within the system, such as in the processing/storage device 203, or via a separate device, such as to notify the officer that the device is recording, or not recording, or full, or any other beneficial function in a covert manner. Such vibratory functionality may be provided by a separate device, possibly independently powered. The system may be configured so that when the recorder activates, a one second vibration is felt by the officer to covertly notify him the system has activated. Other vibratory notifications (e.g. sporadic vibration, one half second vibration, etc.) may be incorporated to advise the officer of other functions or notifications. The vibratory function may be provided as an option and may be incorporated into the processor, camera or some other type of device located on the person of the officer.

Also provided may be a command center alert override button or switch to override alerts to the Command Center when the device is triggered, a USB plug interface, docking cradle, programmable recorder controls, ability to provide a Wi-Fi hotspot and/or Wi-Fi connectivity, Wi-Fi Time Synch, and commercial wireless service may be provided. It may be understood that an existing smartphone may be modified or employed to perform some, many or all of the functions required of or optionally offered with the processing/storage device 203.

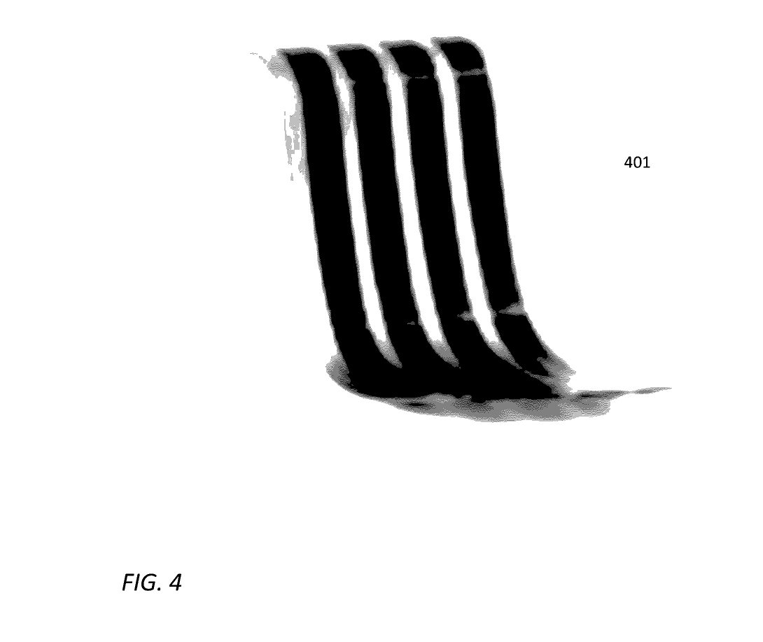

With respect to the belt 201, several pieces of nylon have in the past been sewn, glued and pressed together to form the duty belt. A thin circuit tape 401, such as is shown in FIG. 4, can be provided with, e.g. sewn into, the belt. The circuit tape 401 can possess multiple individual electrical lines/leads running through it. The circuit tape 401 is sewn into, fixedly mounted within or outside of the belt and may not be visible once the belt is assembled.

In one aspect, belt 201 may have metal grommets or similar items embedded in its inside portion. The metal grommets may be threaded so that a small screw or bolt can be screwed into the center of the grommet. Each pouch or holster has two small metal grommets on the rear loop (not threaded). Each pouch is slid on the duty belt via the loop and placed in the appropriate location on the belt. Small screws or bolts are provided through or to the metal grommets on the pouch loop and into the threaded grommets on the duty belt. This secures the pouch into the designated location on the duty belt. Two grommets are provided on the pouch or holster loop. An embedded wire runs from each pouch loop grommet to each end of the metal snap which is utilized to secure the pouch flap on the pouch or holster. The screws or bolts screwed through the grommets on the pouch and into the grommets on the duty belt extend far enough into the duty belt so that they contact a designated lead on the circuit tape embedded inside the belt. This implementation creates a circuit that can be utilized by the system. When the holster or pouch is snapped closed, a complete circuit results. Unsnapping the holster or pouch breaks the circuit and activates the processing/storage device 203 which would also be connected to the system in a similar fashion. Each style of pouch (holster, handcuff pouch, OC spray pouch, electroshock weapon holster, baton holder) has grommets embedded or connected at a different height on the belt 201. Different height positions cause the different devices to always utilize different leads/wires on the circuit tape, enabling processing/storage device 203 to recognize which pouch has activated the recording device. The belt 201 has a number of grommets embedded in the inner portion of the belt 201, throughout its length, enabling each officer to position equipment pouches and holsters in locations that are the most comfortable and efficient.

Alternately, circuit tape may be affixed, such as sewn, into the length of belt 201 as noted above. In this embodiment, grommets or the like are not provided in the inner portion of the belt. Each pouch or holster possesses a standard belt loop that slides onto and secures the pouch or holster to the belt 201. An additional metal hasp or similar device is affixed to the back of the pouch or holster. Once the pouch or holster is slid onto the belt 201, the metal hasp or similar device is closed over the back of the belt 201 and secured. The metal hasp may include two pins that puncture through the outer material (on the inside of belt 201) and connect into the circuit tape within belt 201, creating a circuit. The metal pins of different types of pouches or holsters may be positioned at different locations on the metal hasp to ensure different circuits are utilized on the belt 201.

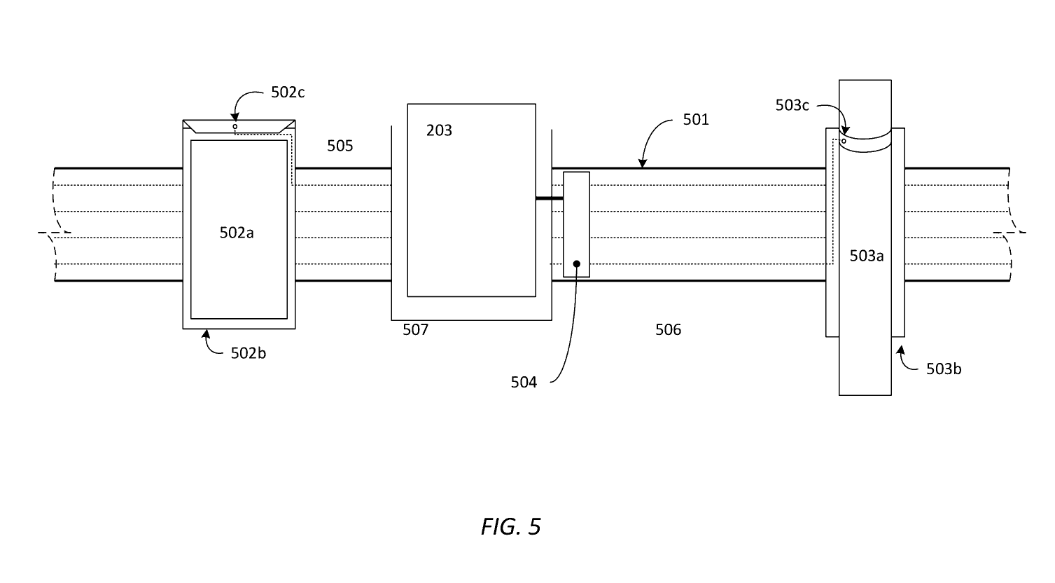

FIG. 5 illustrates the general use of thin circuit tape 401 or similar which may be sewn into belt 501. Two devices and two receptacles are shown in FIG. 5, device 502a and receptacle 502b, and device 503a and receptacle 503b. Electrical connections, such as grommets, snaps, or other appropriate devices are shown as electrical connections 502c and 503c. Processing/recording device 203 is shown, and in this view intermediate device 504 is provided, wherein intermediate device may be a transformer, signal booster, multiplexing cable, or any other intermediate device that facilitates providing electrical connections and indications from the receptacles and their components or connections to processing/recording device 203. A direct connection, without intermediate device 504 may be provided. From FIG. 5, receptacle 502b connects to wire 505 using electrical connection 502c, while receptacle 503b connects to wire 506 using electrical connection 503c, and wires 505 and 506 in this embodiment connect to intermediate device 504, which connects to processing/recording device 203, here housed in receptacle 507. Other implementations are possible, such as two or more receptacles using a single wire such that removal of any device constitutes a critical event and the processing/recording device 203 senses that a critical event has occurred. Such an implementation may not be able to record and/or document which device was removed from its receptacle. While a limited number of electrical lines are shown in FIG. 5, any number of lines may be provided, with some lines not employed to make an electrical connection. Additionally, different electrical lines maybe utilized by different types of pouches or holsters. This would allow the system to know which item is being deployed based on the electrical lines (circuits) being broken or activated.

The processing/storage device 203, able to record audio and/or video, may sit or be seated inside a dedicated pouch designed for the device. Inside the bottom of the processing/storage device pouch may be a “male” electronic interface plug, while the bottom of the recorder body may have a “female” electronic interface plug which mates with the “male” plug in the pouch.

The processing/storage device pouch is secured to the duty belt via a loop. The processing/storage device pouch loop may have a large dedicated oblong grommet. Once small screws/bolts secure the loop to the belt 201, the processing/storage device pouch forms a circuit with the other pouches and holsters on the belt 201. When the processing/storage device is placed inside the processing/storage device pouch/enclosure, it interfaces with the belt, pouches and holster via the electronic interface plug. The processing/storage device pouch holder may be waterproof and provide substantial protection to the processing/storage device 203. Basic functions can be activated while the processing/storage device is in its pouch, including but not limited to the activation of the slide switch (to initiate manual recordings), and bookmark and index button functions.

Generally the processing/storage device 203 may be positioned on an outer surface of belt 201 near the center of the body. The processing/storage device 203 may be activated by the officer manually with either hand. The processing/storage device 203 may be a mini computer having a shape and style similar to a smartphone or may be an actual smartphone. Additional capabilities and components can be integrated using such a device (GPS, remote listening, etc.). All actions and triggers can be date/time stamped and recorded via the processing/storage device 203. A smartphone style device typically includes a large LCD screen that may be used for reviewing video and checking the functionality and settings of the device. Such a device can be upgraded and reconfigured depending on needs and requirements.

The processing/storage device 203 has digital audio recorder capability. Digital audio recorders can retain/record several days of recorded material, versus small cassette recorders which may have a maximum of, for example, 15 minutes of recording time. Digital audio recorders can download their recorded material onto a CD or directly to a digital storage medium eliminating the need to purchase and store costly analog tapes. Significant recorded incidences can also be quickly copied and e-mailed in native or compressed digital format.

As noted, processing/storage device 203 is constantly recording and erasing audio and/or video. The device can be set to constantly record and retain recordings for almost any reasonable period of time, such as from 5 seconds to 5 minutes, a time value that can be modified by a computer system administrator. Once a pouch is unsnapped or a manual recording is initiated (critical event) as described herein, the processing/storage device 203 immediately saves the previous X seconds of recorded footage and begins recording in “live time.” This will not only allow an incident to be recorded but also save the preceding X seconds prior to the recorder being activated. This capability may be disabled so that the device only activates once something is triggered (equipment deployed) or manually activated. At that point the device activates and records until shut off.

An officer may be able to activate the recording device manually. There will be times when an officer comes into contact with a citizen and wishes to record the incident surreptitiously even though an arrest is not made and no force is utilized. These incidents can include a traffic stop, contacting a victim, confession by a suspect, etc. A recorded contact will additionally protect the officer from false allegations or complaints.

The processing/storage device 203 may include a slide activation switch. The slide switch would allow the officer to activate and deactivate the recorder easily and positively without looking at the device or removing the processing/storage device 203 from its pouch. The slide switch will normally rest in the “stop” position, can slide up into the “record” position to initiate a manual recording, and down into the “stop” position to stop the recording (or other variations incorporating a switching mechanism). Additionally, upon activation, the processing/storage unit 203 or integrated accessory may provide a vibratory notification of a change in status (turned on, turned off, remote activation, etc.).

A number of currently available digital recording devices possess a “soft key” (one push button) to initiate and terminate a recording. This same soft key may be provided to activate and stop the processing/storage device 203. While there can be issues with such a soft key, such a soft key may be provided with the processing/storage device 203.

An officer's holster is integrated into the belt system. When an officer unsnaps the retention device of his handgun holster, this breaks the electrical circuit and activates the system. The officer's processing/storage device 203 activates automatically (with an X second recording buffer). A GPS alert may be sent automatically to a command center notifying them the officer has deployed his/her handgun and of his/her location using current GPS coordinates or other geographic information regarding location of the processing/storage device 203. Other designated pouches on the officer's belt are also integrated into the belt system. When an officer unsnaps a designated pouch (OC spray, electroshock weapon, baton, handcuffs, etc.), this breaks the electrical circuit and activates the system, again activating the recording function, and a GPS alert is sent to the command center indicating the officer has deployed his/her OC spray, electroshock weapon, baton or handcuffs and his/her location. Typically pouches or containers for devices linked to risks of liability would be integrated electrically into the system. As an example, drawing a small handheld flashlight from its holster, may not be desired to activate the recording system and may either not be connected to processing/storage device 203 or may not trigger a recording and/or alert to the command center if desired. Additionally, the system may be configured to stream live video to a command center or other officers when activated (for example, an officer drawing her handgun) or the system may be configured so the command center can remotely activate and stream video to the command center for viewing in live time. The processing/storage device 203 may offer play, rewind, and fast forward functionality. These capabilities can be utilized by the officer to review recorded material while still in the field. In some circumstances an officer will record statements from a victim, witness or suspect. He/she may be provided the ability to review these statements so that he/she can prepare an accurate report, subject to the security features discussed above. A simple slide switch can be utilized to initiate these functions, or multiple buttons may be offered. If the processing/storage device 203 has a touch screen, these buttons can be built into the screen software.

The processing/storage device 203 may have a “file” button that can be accessed while the processing/storage device 203 is in its pouch. Once a contact/recording is ended, the officer may invoke the file function to create a new file for the next contact. In this manner, the officer can create an individual date and time stamped file for each contact without removing or looking at the recorder.

If all recordings during an officer's shift are recorded in the same file (recorded material added to the same recorded file as the day went on), such operation could create significant problems. First, it would be extremely difficult to find individually recorded incidents from the officer's shift. The officer would have to manually listen to the recording to find a specific incident. Second, if an arrest was made on the same file as the unrelated incidents, legal representatives of an arrestee may be able to obtain and review unrelated matters. The officer or his/her supervisors may not be able to “alter the original recording” to only provide the incident of the arrest in question. Creating a separate file for each separate incident/contact, during the officer's shift, creates a recording, which pertains only to the incident in question. Additionally, each file is listed with the date and time the recording was initiated, assisting in the overall management of the recorded incidences.

The processing/storage device 203 or related accessory may provide a “bookmark” button accessible while the processing/storage device 203 is still in its pouch. The purpose of the bookmark feature is so that the officer can “bookmark” a portion of the recording during which significant incidents occur. For example, during the same incident, an officer may bookmark the time when he contacts a victim, when he contacts a witness, and when he interviews a suspect. When the officer prepares his/her report, he can quickly forward to the bookmarked portion of the recording (when he contacted the victim) and review the recorded statement of the victim. Without the bookmark feature, the officer would have to manually listen to the recording to review specific recorded incidents and interviews.

A folder function may also or alternately be provided to create separate folders for recordings. A folder can be created for each shift so that all recordings for the shift are grouped together, and may be helpful if an officer does not download his/her recorded material at the end of each shift. In that case, the officer can create a new file for his/her next shift. Files may be labeled with the date and shift of the officer for easy reference, either automatically or by the officer.

The processing/storage device 203 may have an override or “off” switch that will shut off the recorder in case it is accidentally activated. Although the recorder may have a slide switch to initiate manual recordings, this switch will not slide into the “record” position when the recorder is activated by, for example, a pouch being unsnapped. As such, a means to manually shut off the recorder is provided.

One option to turn off the recording once initiated, by the officer or by critical event, includes an additional button/switch on the processing/storage device 203 to deactivate the recording. A second option is to employ the slide switch to effectuate this operation. The slide switch will normally rest in the “stop” position (e.g. a middle position) and may be repositioned to the “record” position. The slide switch stays in the record or stop position until physically manipulated. The slide switch can also be pushed/slid into an “override off” position that will stop the recorder if activated due to a pouch or holster being unsnapped. The slide switch will not remain in the “override off” position once the officer releases downward pressure. Such a switch may be a momentary switch that automatically slides up into a “stop” position so that it is ready for use. This will prevent the officer from accidentally leaving the switch in the “override off” position and therefore disabling the automatic activation of the recording device when a pouch or holster is unsnapped.

Utilizing the override off switch will stop the recorder from recording based on an automatic trigger (pouch unsnapped). If a pouch remains unsnapped (i.e. handcuffs are removed and used on suspect), the processing/storage device 203 continues to record until the manual override switch is depressed. In that case, the processing/storage device 203 stops recording even though the handcuff case remains unsnapped. The processing/storage device 203 will once again reactivate and record automatically as described if a different pouch is unsnapped, such as the handgun holster. The system may reset automatically or be manually reset once all pouches are re-snapped (i.e. handcuff case is closed again). All activations and deactivations may be recorded and date/time stamped to provide overall management of the system.

The processing/storage device 203 may include a high quality microphone built into the body of the device. The microphone may be positioned on the device to receive an acceptable amount of audio input while worn on the officer's waist. The processing/storage device 203 may further include a display screen, such as an LCD display screen, built into the body of the device and visually providing the officer with information pertaining to files, folders, recorded time, battery power, diagnostic information, etc. The display screen may employ a backlight so that it can be viewed in dark conditions and may be configured so that it is not visible when it is placed in its pouch. The processing/storage device 203 may also include a light indicator, such as a red LED light, in or at the top of the device. The light indicator lights up when the recorder is recording. When the recorder is placed in its pouch, the LED light may be viewed from a direct downward angle by the officer, enabling the officer to visually check to see if the recorder is recording by simply looking down at the recorder pouch.

The processing/storage device 203 may be provided with an audio speaker plug or interface allowing an officer to plug a patch cord, USB or other cord from the recorder to an external speaker, headphones or computer to listen to a recording. The audio speaker plug also allows the officer to plug a patch cord (or similar) from the digital recorder to a conventional analog tape or digital recorder, enabling the officer to make conventional analog tapes to be booked as evidence. The audio speaker plug allows the officer to play back recorded footage at a much louder sound level and with more clarity. This can be utilized when multiple persons are reviewing the recorded footage. Utilizing an external speaker, such as one with its own power source, prevents the digital recorder from utilizing its own power source for playback. The processing/storage device 203 may offer an audio microphone plug in the body of the processing/storage device 203. The microphone plug allows an external microphone to be plugged into the device. Some officers may prefer that a separate microphone be located closer to their face in order to better pick up conversations. This ability will also allow the processing/storage device 203 to be utilized to record audio from preset microphones built into police cars, interview rooms, and so forth. Utilizing a patch cord, USB or similar device is a way to transfer a high quality audio recording from an analog tape recorder to a digital recorder, such as threats recorded on a telephone answering machine). The location of the audio microphone plug may be in a position to allow an external microphone cable to be plugged into the processing/storage device 203 while still inside its pouch.

The processing/storage device 203 is rechargeable with removable batteries, with a battery dependent recording time of average quality video and/or audio recordings, such as an 8 or 12 hour recording time. The processing/storage device 203 may display the power level and indicate the amount of recording time left. The processing/storage device 203 can be recharged by placing it in its charging/download cradle. Rechargeable batteries may be removable so that they may be changed when they are defective of if the officer works longer than the power life of the batteries. Standard sized batteries may be accommodated and may be used as the source of power.

The processing/storage device 203 has the ability to be charged via a cable while still located inside the pouch 210 on the officer's belt. This will allow an officer to plug a charging cable into the system while seated inside his/her police vehicle, ensuring the system remains fully charged. The processing/storage device will detach from the system when the officer exists his/her vehicle.

A removable memory medium may be employed with the processing/storage device 203, but a fixed internal memory may also or alternately be used. One memory media that may be employed is that of a “Secure Digital” format (SD card) or similar format. Utilizing removable media enables the officer to download recorded information by removing the SD card and placing it into a computer implemented SD card reader or other reading device. The removable memory card may be placed directly into evidence in an instance of an officer involved shooting. A small access door can be provided in the body of the processing/storage device 203 allowing access to the memory medium. The access door protects the memory card and can be provided with a watertight seal. Alternatively, the processing/storage device 203 may incorporate a non-removable memory medium. This would prevent allegations of tampering with recorded video/audio data.

Recorded material can be downloadable to other media, including but not limited to CD or DVD. The CD or DVD can then be placed into evidence as the original video and/or audio evidence. The recorded format may be compatible with a standard format, such as Windows Media Player and QuickTime. An issue with many current recordings systems is they record in a proprietary format which requires a proprietary software player to playback audio/video. In the public service arena, most computer users do not have administrative rights to their computers and users cannot download proprietary software. Thus a standardized format is generally preferable, but not absolutely required.

The processing/storage device 203 may be provided with anti-tampering functionality, such as anti-tampering software. Such software prevents video and/or audio files from being tampered with, altered or modified whether the recorded incident is on the processing/storage device 203 or if it has been downloaded into a computer. Such technology is widely available. In general, the inability for the officer to erase or alter recordings is provided, with internal components such as time and date stamping of video and/or audio, providing codes to the file and/or footage, identifying critical events or on times for the processing/storage device 203, and recording such information in a location where it cannot be altered or destroyed, and so forth, where a computer user can determine when the recording has been altered or removed.

Other methods include a feature where downloading a video or audio file to removable media such as a CD or DVD causes downloading of a small portion of the software player is downloaded also. Such functionality allows the audio recording to be played by any computer. If the audio file is altered, the audio file no longer functions and the tampering attempt may be logged.

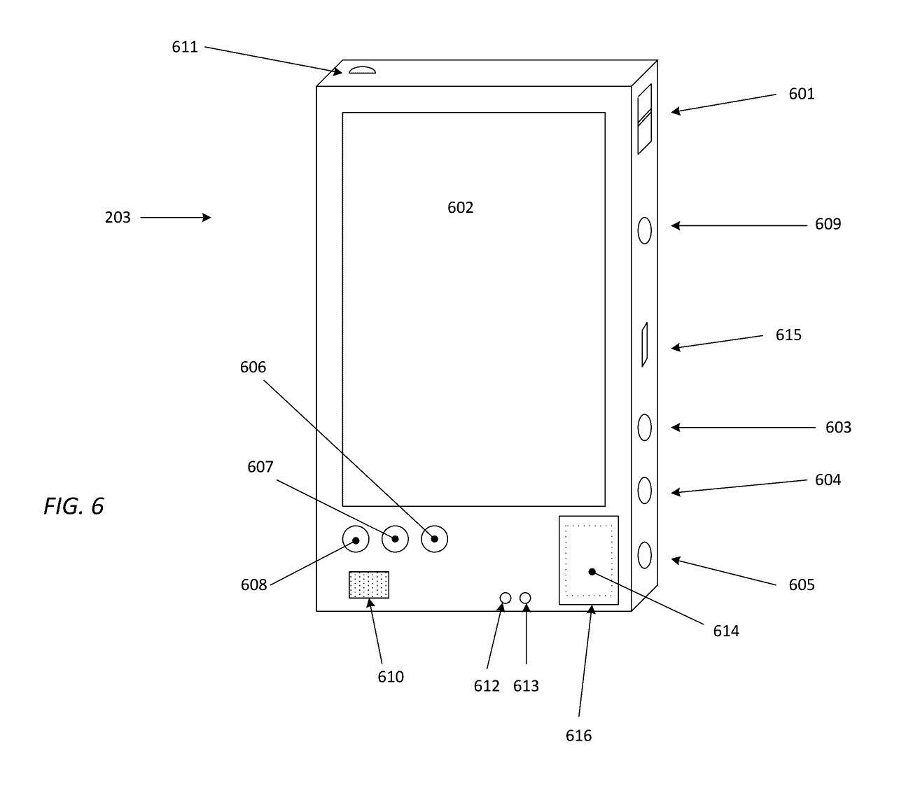

FIG. 6 illustrates one embodiment of a processing/storage device 203, with certain features that may or may not be provided. Slide/activation switch 601 is shown, screen 602, play button 603, rewind button 604, and fast forward button 605, file button 606, bookmark button 607, and folder button 608. As discussed and may be appreciated, buttons may be hardware or software, and any button can be either hardware or software. Off switch 609 is shown, as well as microphone 610, activation light 611, speaker plug 612, microphone plug 613, battery/batteries 614, card slot 615 for an SD card, for example, and access door 616. More, fewer, or different features may be provided. The case or body of processing/storage device 203 may be manufactured from a durable metal or composite. Buttons provided on the processing/storage device 203 can be programmed and reconfigured as desired and may be positioned in any logical manner, including a manner different from that depicted in FIG. 5. A touch screen display may provide additional buttons that can be easily changed and reconfigured based on the agency's needs.

As shown in FIG. 2, a small or miniature video camera or recording device can be plugged into the processing/storage device 203. The camera can be clipped onto the pocket of the officer's shirt, glasses, collar, pocket or any other area, allowing the video camera to capture the viewpoint directly in front of the officer. Alternately, the video camera may be incorporated into the radio handset. Uniformed police officers carry a handheld police radio on their belt, and a handset microphone/speaker may be connected to the radio via a cable. The officer clips the handset onto the V neckline of his/her uniform shirt, enabling the officer to listen to his/her radio and transmit via the handset without removing the handheld radio from its holster on his/her belt. The radio handset is clipped in an acceptable location for a video camera (front center of the officer's body on the neckline of his/her shirt). A small video camera can be incorporated into the radio handset, eliminating the additional cable and camera necessary for the video recorder.

A small video camera, attached via cable to the system, can be clipped onto the existing radio handset issued to officers, providing a simple and secure mounting surface on the officer and ensuring the camera is pointed directly in front of the officer. Different clips may be employed to accommodate various radio handsets. The camera clipping mechanism can be designed as a modular accessory by third party manufacturers. Alternately, a video camera can be mounted onto the belt 201 or built into the processing/storage device 203. Such camera mounting may be for officers not wanting the additional cameras and cabling necessary to attach a camera separate from the system. Alternately, a camera may be clipped onto a pocket or other area of an officer's shirt, attached via a cable to the system. In a military scenario, the officer may have the device attached in another appropriate manner, such as to a helmet or vest.

The processing/storage device 203 may employ an acoustic gunshot activation feature, able to determine a gunshot as a critical event and effectuating the critical event processing described herein. Gunshots have a relatively unique acoustic signature, and processing/storage device 203 can begin recording if a gunshot is detected in the vicinity of the officer. This feature may also notify the police command center with the type of trigger (gunshot detection) and the GPS location of the officer.

Any acoustic sensor can provide false positive readings and triggers. The system may be configured to send a highest priority alert to the police command center if both an acoustic gunshot activation is detected and if the officer's handgun was removed from its holster during the same time period, i.e. within a certain period of time, such as two or five seconds. One example of a gunshot detection device is employed by the U S military and is called the Shoulder-Worn Acoustic Targeting System (Ears SWATS), is manufactured by “QinetiQ North America,” deployed on soldiers in Afghanistan. This system not only detects gunshots, but utilizes triangulation technology to designate the direction and potential location of the shooter. Similar functionality may be employed, or a lower level of functionality as desired, such as determining existence of a gunshot in the vicinity.

The system may also incorporate a “protractor” and/or “gyroscope” type functionality in which the processing/storage device 203 or other integrated accessory measures the angle in which the device is currently positioned. Such a function may be used to create a trigger and subsequent GPS notification to a command center in, for example, a situation in which an officer draws his/her handgun from a holster. The system notifies the command center that a processing/storage device 203 connected to the officer is laying in a 180 degree position suggesting the officer may be laying on the ground. The command center can then dispatch aid to the officer's location.

A diagnostic/self-check feature is employed in processing/storage device 203. This feature can be utilized by the officer in an attempt to ensure the system is functioning properly at the start of each shift. The display screen may inform the officer if the device is functioning properly or if there is a specific problem. The diagnostic feature may check to ensure all circuits on the belt, pouches and holster are functioning properly. A separate light or indicator, such as an LED light can be incorporated into the recorder as a diagnostic test. This indicator may flash or go on when an officer unsnaps each pouch/holster at the start of each shift, show the officer any problem and allowing him to easily identify the problem component, e.g. pouch or holster.

The processing/storage device 203 can optionally be set to maintain a record/log of all recorded incidences which have been erased from the device. The processing/storage device 203 may log and/or transmit the date the original recording was initiated, the time the original recording was initiated, the length of time the original incident was recorded, the time the erased incident stopped recording, the number of times, dates, and/or time the recorded incident was reviewed/listened to before it was erased, whether the incident was downloaded to a computer prior to erasure, the date and time the incident was erased, whether the incident was erased on the digital recorder or from a computer, and if the processing/storage device 203 was checked to see that an incident was erased. Each of these occurrences may be monitored and logged as appropriate and as desired.

Supervisors or administrators of groups of officers may have a dedicated management software tool, installed on police agency computers, which will allow them to track the above listed log entries while the processing/storage device 203 of the officer cannot reveal these contents and the officer cannot alter these contents. If an officer records an incident and then attempts to erase the recording, the administrator may be notified but at the very least will be able to see the erasure attempt. The administrator can then inquire of the officer why he/she erased the incident and/or attempted to erase the incident. The processing/storage device 203 can be configured so that multiple steps are needed to erase a recorded file, tending to decrease the possibility that an incident can accidently be erased. Alternately or additionally, the processing/storage device 203 can be configured so an officer cannot delete any files from the device, preventing inadvertent deletion. The system can be configured so recordings can only be erased by a police administrator after the recordings have been downloaded.

The processing/storage device 203 can be equipped with a lockable memory medium access door. The access door can be unlocked via a special key. Administrators (not individual officers) can be issued a key to open the memory medium access door to prevent tampering by the individual officer and preserve the chain of evidence of the memory medium.

Radio Frequency Identification Devices (RFID) can be provided in the pouches and holsters utilized by the system. This will allow the processing/storage device 203 to identify the types of pouches/holsters attached to the belt 201. The processing/storage device 203 may create a log of the pouch or holster that is used to activate the processing/storage device 203 (including date and time) to indicate what equipment was utilized first (e.g. OC spray, baton, electroshock weapon, handcuffs or handgun). The processing/storage device 203 will also identify subsequent deployments of each item of equipment to provide an accurate time stamped log of the escalation of equipment usage by the officer. For example, the officer may deploy/her OC spray and therefore activate the recording system. When the officer deploys his/her baton, the recording system is already activated and continues recording, the deployment of the baton will cause the log to indicate the time this critical event occurred. The system will also log the officer's deployment of his/her handgun and eventually handcuffs, including date and time of each of these critical events, all the while recording the situation.

Modern law enforcement vehicles are equipped with Mobile Digital Computer (MDC) systems with wireless capability. The MDC is usually a laptop or trunk mounted computer processor with LCD screen mounted to the dashboard of the vehicle. The MDC transmits/receives data via commercial wireless (cellular air cards). This same MDC has the normal wireless, Wi-Fi and Bluetooth capabilities of most modern laptops. These capabilities may be utilized to interface the belt 201 and system with the computer housed in the police vehicle. This interface may provide additional capabilities and storage redundancies for the system. A similar arrangement may be available and/or employed in the military context, as is true for all of the functionality described herein.

As an example in the law enforcement setting, whenever the officer is within a short distance of his/her vehicle, the system on his/her waist may transmit all recorded media (recorded incidents) to the hard drive of the vehicle's computer. When personnel drive the police vehicle to the police station parking lot (equipped with municipal Wi-Fi/wireless internet), the police vehicle computer wirelessly transmits the recorded material to law enforcement storage servers. Additionally, this function may be replicated via standard commercial wireless that is already in use as a method of data transmission in police cars.

RFID, WiFi, Bluetooth or other wireless technology may be utilized in a hybrid fashion with the system. For example, shotgun and AR-15 rifle locks located in a police vehicle may be connected or configured with RFID/Bluetooth functionality. When the officer unlocks and/or removes a shotgun or rifle from his/her vehicle, the RFID signal sends a trigger to the officer's processing/storage device 203 on his/her belt 201 to initiate a recording. These represent possible additional critical incidents that may initiate recordings.

Other Critical Events

The use of a gunshot detector is described above, but other events and/or actions may be used in determining a critical event. For example, an RFID/Wi-Fi/Bluetooth (or other wireless) system could alternately or additionally be connected to the siren and police lighting system of a police car. In this manner, the processing/storage device 203 is activated and begins recording when the police vehicle's lights and siren are activated, such as at the start of a vehicle pursuit. The RFID/Wi-Fi/Bluetooth (or other wireless) system may also or alternately activate the processing/storage device 203 if the officer initiates a traffic stop by activating the solid red light on the police vehicle's police light bar. Alternately or additionally, the system may interface via RFID/Bluetooth to wirelessly connect to crash sensors mounted in the police car. In this embodiment, in the event of a traffic collision (high liability risk event), the car's crash sensors activate and transmit a signal to the system. The processing/storage device 203 then activates, records, and saves the X seconds prior to the collision.

Deployment of other equipment, such as equipment not provided with a duty belt, such as rifles, shotguns, and/or less lethal launchers or other items of equipment may be provided with sensors or electronics that transmit to the processing/storage device, such as wirelessly. The desired apparatus may be equipped with a sensor (associated with or connected to a retention snap, strap, or other retention means) and altering the state of the retention snap, strap, or other retention means causes a signal to be transmitted to processing/storage device 203. Deployment of a particular weapon or device, such as a device normally located in an officer vehicle, may also or alternately activate the processing/recording device 203 to begin recording as described herein, and may provide streaming video to a remote location, such as the command center, and may provide associated GPS coordinates. WiFi may be incorporated into or with the weapon or device to provide wireless connectivity to the processing/storage device 203 and wireless technologies (Wifi, RFID, Bluetooth or other) may be used to integrate the belt system and processing/storage device 203 into desired assets of a police vehicle or its equipment.

Additionally, police officers utilize a handheld police radio in the performance of their duties. The radio is placed inside a radio pouch, which may additionally be attached to the present system. If the radio's emergency trigger switch (E-trig) is activated, this can also activate the processing/storage device 203.

The inside bottom of the radio pouch may include a radio interface that matches the radio. When the radio is slid into the radio pouch, the radio joins to the present system. An alternate approach is to provide a different radio handset interface which incorporates connectivity with the present system, enabling recording of audio transmissions or uses of the police radio.

Existing handheld police radios now have the option of incorporating GPS (Global Positioning System) information. When the radio's “emergency trigger switch” (E-Trig) is activated by an officer, an “emergency” signal and the officer's location is automatically transmitted, by the radio, to a command center. This provides the officer with an immediate police backup response when he/she does not have time, ability, or presence of mind to request assistance verbally, such as when the officer is involved in a fight. This option can be added to existing police radios by incorporating a new handset with an embedded GPS receiver or other accessory.

A significant issue with the existing police radio and integrated GPS system is that officers in escalating situations often do not have time to activate the emergency trigger of their radio to transmit the GPS signal and location. The “Achilles' heel” to existing GPS technology is the need for the officer to consciously initiate an administrative action, such as pushing a radio button, prior to taking law enforcement action. For example, an officer involved in a shooting is generally too busy drawing and firing his/her handgun to push a button on his/her radio until after the incident is over. GPS transmission to the police command center is preferably immediate and automatic.

When the police radio (with GPS technology) is integrated into the present system, the officer's level of safety increases significantly while potentially reducing liability. An officer deploying his/her OC spray, electroshock weapon, baton or handgun, activates the processing/storage device 203 and may send an alert to the command center, via the integrated police radio, notifying the command center of the officer's GPS location. This GPS alert may indicate the item deployed from the officer's belt 201. The command center can then deploy additional police units to assist the officer and/or attempt to contact the officer via radio for his/her status. Such functionality may be accomplished via the integration of commercial wireless (cellular) into the system. The commercial wireless can be a back-up system to the integrated radio/GPS system or can act as a free standing system.

If the officer attempts to make an arrest, he/she will unsnap the pouch or retention device holding his/her handcuffs, activating the processing/storage device 203 and possibly sending an alert to the command center that the officer's handcuffs have been removed and his/her GPS location. The command center may dispatch “back-up” police units and/or a supervisor to the officer's location without oral request by the officer. Such functionality provides an increase in officer safety. In this configuration, the officer's radio or processing/recording device 203 (via commercial wireless or other method) may only send GPS coordinates to the command center when the officer is about to make an arrest, utilize significant force, or draw his/her handgun, where each event triggers the recording using the processing/storage device 203. In all of these cases, the officer will likely want the command center to be notified of his/her location so back up officers can respond.

The system can be tailored so that only specific pouches/holsters activate the GPS alert to the command center. For example, agencies may require that a GPS alert only be sent to their command center when an officer removes his/her handgun from its holster. Other agencies may require such alert no matter which item is removed from the officer's belt. The processing/storage device 203 is able to identify the type of pouch or holster which has been unsnapped, the retention system disabled, and/or which police item was deployed, such as by sensing altered voltage or current on the wire connecting the handgun holster, for example, to the processing/storage device 203. This information may then be transmitted to the police command center via the police radio or commercial wireless (or similar technology) incorporated into the system. The command center will then know which one of the officer's police devices has been deployed. If the officer deploys/unholsters his/her handgun, the command center may deploy resources differently than if the officer deploys his/her handcuffs. As an example, this specific notification feature may be beneficial if an officer unholsters his/her handgun and the processing/storage device 203 detects the acoustic signature of a gunshot. Such a scenario may indicate to the command center that the officer is in an officer involved shooting and the command center may receive the officer's GPS location.

It would be beneficial if the officer knew every instance when he or she was recording using the present system. Recording could be inadvertently initiated, which is undesirable. The system may notify the officer in some manner each and every time the recording device is activated. Audible tones or beeps or light flashing may be employed, but these may not be desired. Alternately, a small vibratory device may be attached to or provided with the system. Such a vibratory device may be separately powered and provide a one second vibration alert any time a pouch or holster is unsnapped, producing a vibratory alert similar to that provided by a cell phone. The vibrating may be turned off manually or when the recording is stopped. The vibratory alert may be used as a signal for a variety of functions including but not limited to the device being activated, the device being turned off, low battery notification, etc.

When an officer unsnaps a pouch integrated into the present system or otherwise encounters or acts to perform a critical event, the officer may feel a vibration alert on his/her belt for a certain duration, such as one second. This vibration notifies the officer that the processing/storage device 203 has been activated and has started recording X seconds prior to activation based on the X second recording buffer feature.

The vibratory alert may not be incorporated into the processing/storage device 203 as this would increase the size of the device, waste processing/storage device power, and may cause recording interference issues when the vibratory alert is sent. Vibration strength may be adjustable so that the officer feels the device vibrating on his/her belt (notifying him/her the recorder is on) but vibrates at a level not so great that the vibration becomes distracting. The purpose of this option is to ensure an officer is notified when the processing/storage device 203 is actively recording if a pouch is accidently unsnapped. As an option, this function may not be integrated into the handgun holster of the system, as it is generally unlikely the officer would not know the holster on his/her handgun has been unsnapped. Not integrating the handgun holster into the vibratory alert option may ensure the officer is not distracted by a vibration on his/her belt if involved in an on-duty shooting. The vibratory alert may be provided as a “reminder feature” of the system. In this case, the officer may receive a one second vibratory notification every Z minutes (any predetermined time period) to inform him/her the system was still recording. When an officer deploys equipment for relatively long periods of time, such as handcuffing a suspect and taking the suspect to jail, the officer's integrated handcuff case may be unsnapped for an extended period of time, such as over an hour, triggering the system and recording for the entire time period. The vibratory alert may notify the officer of the recording, at which time the officer could elect to turn the recording off when no longer necessary.

An override switch, such as at a command center, may be provided and/or employed. Whenever an officer unsnaps a system pouch (OC Spray, electroshock weapon, baton, handcuffs, etc.) or his/her handgun holster, the integrated GPS radio or commercial wireless may transmit an alert to the command center. This may produce a false command center notification if the officer accidentally unsnaps a pouch, unholsters his/her handgun prior to entering a restricted custody facility, removes his/her equipment at shift change, etc. The system may provide a Q second delay from the time the officer unsnaps a pouch or unholsters his/her handgun until the integrated GPS radio sends an alert to the command center. During this Q second interval, the officer has time to push an alert override button or switch built into the vibratory notification device or processing/storage device 203. The override button/switch may be built into the vibratory device so the officer will feel the device vibrate when activated. Alternately the functionality may be provided with the processing/storage device 203. This function may cancel the GPS alert to the command center but may still activate the recording device. A situation where this may be applicable is if an officer deploys his/her handcuffs at an incident where numerous other officers are already present. The officer may wish to record the incident but may not want to alert the command center in manner in which it is believed the officer is requesting assistance.

The command center alert override button/switch may prevent the command center from receiving numerous false activations each shift. The command center can then initiate an appropriate response when an officer unholsters his/her handgun and be fairly certain that the officer needs assistance.

If an officer unsnaps his/her handgun holster, the system may activate the processing/storage device 203 located on his/her belt, may initiate a vibratory alert to notify the officer the processing/storage device 203 has been activated and is recording video and/or audio, and send an alert to the command center (within Q seconds) that the officer has deployed his/her handgun, including the GPS coordinates of the officer. The command center may attempt to contact the officer via his/her handheld radio to ascertain if he/she needs assistance from additional police officers. If the officer does not respond, the command center can immediately dispatch additional police units to ascertain the condition of the officer.

The processing/storage device 203 can be manufactured with a retractable USB plug built into the body of the device, allowing the processing/storage device 203 to possess the ability to provide or download information to almost any computer. Other common interface capability may be provided. A docking cradle may be provided to download recorded files to a computer and recharge the recorder at the same time. Officers equipped with the present system may, at the end of a shift, place their processing/storage devices 203 on a docking cradle (not shown) in a supervisor's office, and the docking cradle could be used to download all recorded material. The digital recorder software could be set up to automatically track which officers have downloaded their recordings from each shift. This would make it simple for police administrators to identify which officers have not downloaded their recorded material and for which shift. Many current law enforcement sites, such as police stations, include secure wireless (generally Wi-Fi) “hot spots” that laptops and mobile devices can access to connect to the internet or law enforcement infrastructure. The law enforcement “hot spots” normally encompass the interior of the police station, parking lot and exterior. In one embodiment, when a processing/storage device 203 enters the Wi-Fi coverage of a law enforcement station, a wireless connection may occur, authentication provided, and date and time may be synchronized. In certain instances, the download process of recorded media may commence. A wireless connection, e.g. a Wi-Fi connection, may simplify the process of downloading video and audio recordings from the processing/storage device 203 to police station servers. When an officer enters the station area, his/her processing/storage device 203 may connect to the wireless network and wirelessly download all recorded information into the station servers. No interaction is required from the officer. A similar method has been utilized by in-patrol car video systems.

The processing/storage device 203 may incorporate an LCD type screen to provide information, configuration options and enable review of recorded media. The LCD screen may function similar to that of a smartphone. The officer may connect the device to any computer, such as a mobile digital computer inside a police vehicle, in order to review previously recorded data. The system may have the capability of pushing out recorded media to a computer via wired (e.g. USB, HDMI, etc.) or wireless interfaces (Wi-Fi, Bluetooth, etc.). The system may have inherent safety features that do not allow an end user to manipulate or modify recorded data on the device but merely view such data. Additionally, software may be incorporated which will not allow the export of the recorded data to a computer unless predesignated by an administrator to ensure evidentiary video and data are not disseminated without the express approval of the police agency.

When an officer employing the present system deploys an item of police equipment, the system activates the processing/storage device 203 and may transmit a GPS alert notification to a command center. This arrangement can lead to false activations while officers are, for example, in the police station. The officers could be changing clothes, removing equipment or cleaning their firearms, for example. An optional embodiment of the system entails the GPS alert notification feature being deactivated when the officer is at the station within the zone of, for example, a police station Wi-Fi hotspot. The likelihood is extremely low the officer would be involved in significant use of force, an officer involved shooting or making an arrest in the station area. If such an event took place, numerous other officers would be on hand to lend assistance, and in-station cameras are at times employed to record such events in areas of the station traveled by civilians. When an officer employing the system leaves the area, e.g. Wi-Fi hotspot, the system senses the signal drop and may reactivate the GPS Alert Notification feature. Such reactivation may ensure the officer's location is dispensed to the police command center whenever the officer is involved in law enforcement action in the field. This type of process is generally referred to as a “Geofence” and is defined by an administrator for use by officers and appropriate equipment and devices.

Geofence capabilities of the system can also include the ability to automatically activate the device when the wearer is physically present in specific areas. For example, the system could automatically activate the recording system and notify the command center whenever the officer enters an area which has been known to be dangerous (high crime or gang area) or where there is a significant risk of complaints. The latter example would include a call for service to a home in which the owner has repeatedly made false allegations against law enforcement. In such a case, the system automatically triggers and activates once the officer enters the Geofence area around that physical location.

The system may incorporate various biometric sensors and readers to monitor the various medical attributes of the system user to include, but limited to, heartbeat sensor, pulse, blood pressure, perspiration, voice analysis, etc. Sensors may be incorporated into the processing/storage device 203, camera, pouches, etc. or any variety of items provided. Additionally, sensors may be integrated into an officer's bullet resistant vest, shoes, helmet, hat, clothing, etc. and be connected via hard wiring or wireless methodologies to the system, such as processing/storage device 203. The system monitors these sensors, and may employ, synchronize and/or provide relevant information gathered into recorded video/audio data. Additionally, this sensed information can be transmitted automatically via commercial wireless, Wi-Fi, Bluetooth or other wireless methods to a police command center, which may for example monitor the health and stress of the officer using the system in the field. The system could transmit an officer's location, turn on the recording device, and transmit live video to the command center if the officer's heartbeat elevates to 50% over his/her normal baseline heartbeat level, for example.

Transmissions and communications may be made from and to processing/storage device 203 using commonly available systems, including commercial wireless cellular, Wi-Fi, Bluetooth, and so forth.

Thus various events, signals, information, or data may be transmitted on a wireless network to a remote location, including but not limited to a vibration alert indicating the belt has activated one or more functions or devices, the location of the belt (GPS location), occurrence of a critical event thus initiating recording beginning at a prior point in time, with past video/audio and ongoing video/audio preserved, and video and/or audio transmission to a remote location (police dispatch, supervisor's computer, etc.)

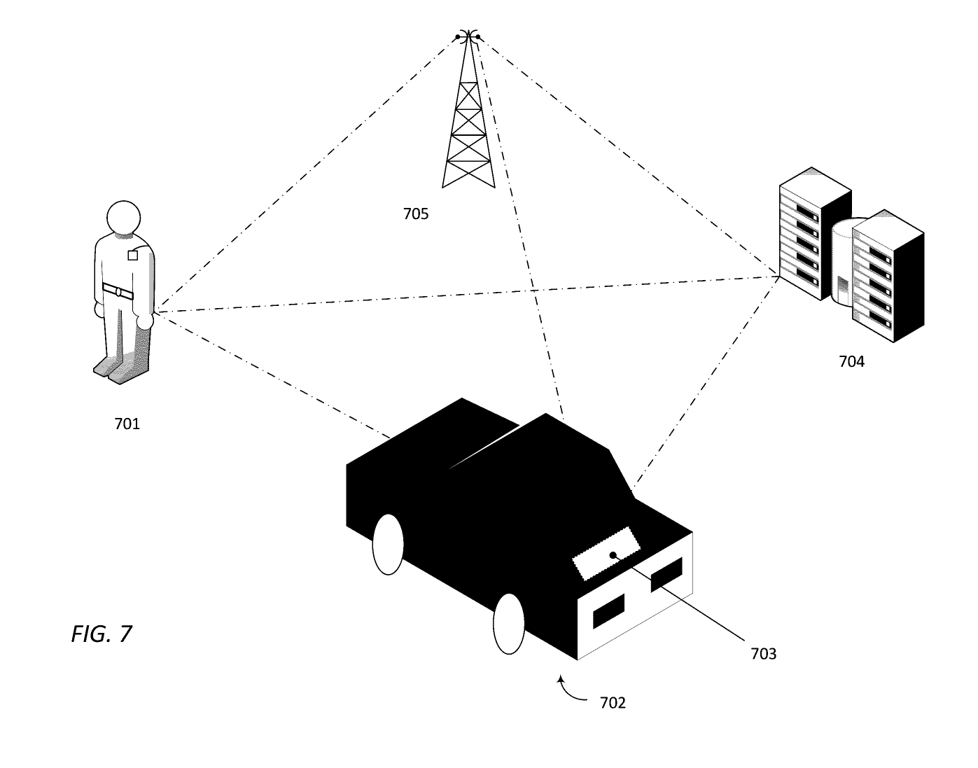

FIG. 7 illustrates a conceptual arrangement when an officer is employing the present system. Officer 701 may remove a device from a pouch on her belt, determined as a critical event by her processing/recording device 203 (not shown in this view). Processing/recording device in this instance marks the continuously recording video and audio at a predetermined time before the device was removed. In this scenario, the processing/recording device may provide an indication of a critical event to a computing device 702 in vehicle 703 which may then provide the critical indication to command center 704, may provide the critical event indication to a cell tower 705 that provides the indication to command center 704, or the processing/recording device 702 may provide the critical event indication directly to command center 704. The incident may proceed to a conclusion, at which time officer 701 turns off processing/recording device 701. In this scenario, the storage capacity of processing/recording device 701 is sufficient to hold additional audio and video, and thus the processing/recording device 203 marked the point where the recording was stopped by the officer, begins recording new ongoing video while not recording over the existing video and/or audio of the incident commencing with the critical event.

At this point, the system may transmit the recorded video in any manner shown if available, such as to the computing device 702 in vehicle 703, and from computing device 702 to command center 704, optionally using cell tower 705, or directly to the command center 704. Alternately, the processing/recording device 203 may hold the audio and/or video recording and may download it at a desired location, such as at a police station, barracks, or control center such as command center 704. This again represents one scenario, and other scenarios are possible, such as the officer driving her vehicle into range of a Wi-Fi hotspot wherein the processing/recording device and the Wi-Fi hotspot are configured to download the recording or recordings to a central server system or network.

Data Management System

The present system manages video/audio recordings, metadata, and/or other information captured by or relating to recording devices, predictive analysis of baseline standards to identify potential issues, monitoring and flagging of high liability events, and integration of video and metadata into a facility or entity such as a Real Time Crime Center (RTCC) computer network, mobile computing system, local computer or other arrangement or process. The system employs analytics to analyze and identify key data and information trends. The system also creates alerts and notifications regarding key events, predefined events or identified thresholds.

The system employs the body worn cameras (BWCs), sensors worn on the body, integration of functions associated with the belt system and camera arrangement described above with police car systems, in-car audio/video recording systems, as well as weapons and police devices including but not limited to long rifles and shotguns, heart beat sensors, gunshot detectors and so forth operating in conjunction with the belt system described. The system further includes video management functionality, predictive accountability and management software, and facility integration, such as integration into an RTCC.

The system also encompasses and/or integrates additional information including but not limited to metadata, video, audio, signal, trigger, analytical information, etc., which may be sourced from multiple locations and technologies not related to the system. These technologies may include but not be limited to fixed CCTV surveillance systems, infrastructure based gunshot detection systems, police in-car-video systems, fingerprint scanners, facial recognition, law enforcement databases, police mobile digital computers (MDC), law enforcement record management systems (RMS), automatic license plate recognition (ALPR) scanners and databases, databases related to calls for service, criminal records, open source internet databases, etc.

Most BWCs record incidents using dedicated audio/video devices utilized to record events where the audio/video files are then stored for evidentiary purposes. The metadata captured by these devices is generally restricted to date, time, duration of recording and possibly GPS location. Some BWC technology allows metadata, including names, identifiers, incident type or code, etc., to be added to incident files after the fact, but this generally requires manual entry thereby introducing human error and delays. Generally, the amount of metadata which can be added after the fact is also limited. This method of adding post incident metadata is difficult, inconsistent, time consuming and inefficient, and does not identify critical trends.

The present system integrates with existing Application Programming Interface (API) functionality in use by current and future BWC manufacturers. The system attaches additional metadata to corresponding recorded video/audio footage in order to provide a more complete and holistic depiction of the events that transpired and were recorded. This metadata is indexable and searchable. The system records and tags various predefined data sets and creates alerts based on analysis of data libraries, enables real time management and prediction of the actions of BWC end-users.

The present system may record particular incidents, such as drawing of a handgun or baton, and assessing whether, for example, one unit of officers draws batons 40% more or 40% less than average baseline established by statistics. Based on this assessment, the manager of the officers may inquire as to the deployment disparity and initiate additional training of the officers if deemed necessary. The system may compile data and analyze or enable the analysis of trends in the frequency of event triggers for individual officers, or the metadata captured during certain events, by analyzing video/audio files and corresponding metadata individually and/or collectively, thereby providing a mechanism for management to proactively mitigate potentially high liability incidents.

In order to accomplish this functionality, a set of criteria is established that is to be maintained, such as time, date, location (e.g. GPS), officer, officer related information (unit, squad, etc.), incident, time of incident, when the incident was in some way resolved (i.e. weapon reholstered, audio/video turned off, etc.), dispatch indications (unit notified of incident, etc.), automobile attributes (speed, direction, etc.), and any relevant situations encountered (gunshot fired by the officer or someone other than the officer, suspect handcuffed, motion (standing still, running), and/or other appropriate situations encountered). The established criteria are typically information pertinent to the officer and his or her current status as well as trigger events established for use with the system, but other criteria may be obtained such as data provided by 911 calls for service, law enforcement records and statistics, etc. Criteria may be changed depending on circumstances.

The information is recorded with the audio and/or video recording in the form of metadata and may be sensed using any of the devices discussed above and provided to a computing device, typically on the officer's person, and the information may be recorded in the form of metadata and provided with the recording. Examples of metadata being recorded include GPS location, deployment of a weapon and a gunshot being fired, where each of these incidents are assigned a given metadata code and the time of the incident is saved with the particular code, typically with the recorded video and/or audio.

The information so recorded is stored and may be provided to a central location for archival purposes and analysis purposes. As an example, the officer may provide his/her recording device including video and audio of an incident and associated metadata to a person or location at the police station. The video and audio may be downloaded from the device, via wire or wirelessly or in any manner known, and the video and audio may be archived and possibly analyzed, and the metadata may also be archived, assessed, and maintained for analysis purposes. Thus a visual and audio recording of the incident and metadata associated with relevant events of the incident may be jointly or separately maintained and/or analyzed.

Analysis of the metadata may include compiling and collection of the data and analysis of the data. Again, the system may analyze the data from a number of officers and training or consideration of the data may be employed. The information may be of little or no value or may be helpful in a variety of instances. If Officer A is being sent into situations where he is encountering gunshots much less often than an average officer, or if Officer Q is successfully resolving situations where she is running after a suspect without drawing any weapons, such information may be useful in determining under what circumstances certain officers can be deployed to increase likelihood of a successful resolution.

Such functionality may be integrated with existing or proposed devices. For example, if a BWC offers an ability to record metadata but does not include the full complement of criteria, the recording criteria may be established and provided with the video recorded by the BWC in conjunction with the BWC API. The function may be added at the BWC, if permitted, or between the BWC and a device that receives and maintains the video and/or metadata. This integration may be achieved via wired or wireless including, but not limited to, Wi-Fi, Bluetooth, commercial wireless, RFID or any or related technology. This device may log and record additional metadata and may then download or transfer this additional metadata into the system along with the recorded video/audio from the BWC. The system may then merge or integrate metadata from the device and video/audio/metadata from the BWC into a seamless ability for viewing, generating reports and predicting behaviors.

Devices that may be integrated into the system include, but are not limited to, systems and/or sensors which may be worn on the body of a person/officer, including gunshot detection systems, various sensors, automated activation devices, accelerometers, Global Positioning Satellite (GPS) sensors, level sensors, heart beat sensor built into a bullet resistant vest (or other body worn system), and so forth. The system may operate with various technologies and systems not worn on the person of an officer. Such systems include but are not limited to Computer-Aided Dispatch (CAD) systems, Records Management Systems (RMS), various technologies integrated in a vehicle such as police car, crash sensors, accelerometers, GPS, geofencing, activation systems integrated into other weapon systems (rifle, shotgun, less lethal launchers, etc.), various sensors, etc. Appropriate interfaces may be provided, such as vehicle status and dispatch arrangements that convey the requisite information to the recording device for the integration of metadata into the saved audio and/or video file.

The system may include integration of functionality into existing systems, such as Record Management Systems (RMS), Computer Aided Dispatch (CAD) or similar databases currently in use by law enforcement agencies. This integration provides metadata to the RMS, CAD or other existing system generated by the automated trigger duty belt and may integrate data received from other sources. This metadata provides additional indexable and searchable data that can be queried and used to generate report functionality.

It should be noted that while the present system contemplates saving metadata of the relevant incidents or criteria with the audio and/or video recorded, any arrangement that provides for the collection of information may be employed, and the information collected may be maintained together with or separate from any audio and/or video recording. Further, the present system stores data and may employ external data such as information from databases, the internet, electronic documents, etc. and may save information to databases, the internet, and/or electronic documents.

As noted, the present system manages video/audio and related metadata obtained from the police belt system described above. The system, including the recording device, may collect and save related metadata and send live information to a remote location such as an RTCC. Again, as an example, when an officer deploys a specific item of police equipment such as a handgun, baton, handcuffs, etc., the system activates a BWC worn on the body of the officer or video recording systems located within the proximity of the belt system as a result of predefined triggers or criteria. Time of the particular trigger or event as well as the officer's GPS location can be relatively important. The system establishes hard trigger points with and on recorded video/audio in real time thereby creating indexable metadata. This recorded video/audio with metadata is then transmitted, exported/downloaded and saved. Additional metadata can be added during the recorded event, on the recording device or via another computer input system after the incident but prior to download, or after the recording has been downloaded to a network server, cloud storage or other storage medium.

Again, trigger points can be alerts such as a handgun being drawn from the officer's duty belt. Once the handgun is drawn and removed from the belt, the system activates the BWC, records what police equipment was deployed, date/time stamps this information, and provides it in the recorded/video audio footage in an appropriate form, such as metadata. The system may also record the GPS location of the device, the GPS location of the officer, the GPS location of the officer's police car, together with the other associated data (date, time, officer, etc.), thereby creating a file that indicates a handgun was drawn by a specific officer in a specific location at a certain time and date. Additional metadata from ancillary systems, such as CAD information from a police vehicle's CAD system, may also be collected and recorded or integrated into the file and saved. This information may then be searched and retrieved based on various searchable fields established using the metadata or other recorded data, enabling the identification of trends based on individual users, GPS locations, time of day, and so forth.

The system manages the automated trigger activation, as well as various rules and routing protocols which may, for example, automatically push out metadata and live streaming video to an RTCC or police command center. The RTCC then monitors situations in live time and automatically dispatches or coordinates additional resources to assist in addressing any given scenario.

The software analyzes the information received or collected using predefined and automated search algorithms and initiates actions based on established parameters and rules. For example, the system may be configured so that a BWC integrated into the system activates when an officer drives or passes within 50 meters of a geo fence, or other boundary as defined by a system administrator, such as when the officer is responding to a call for service at a location which has been identified with a Geofence. Upon arrival at the location, the office may draw his/her handcuffs, initiating the saving of metadata such as date/time stamps, with the metadata potentially integrated into the video together with a live notification of the event (arrival at a location) transmitted to the RTCC. Alternately, the system may automatically identify the officer's BWC and/or device once he/she enters the Geofenced area of the call for service. For example, if the officer is responding to a house during a call for service, the system may cause the officer's BWC to be turned on when he/she is 100 meters from the location. Additional metadata is recorded when the officer exits the vehicle, draws or deploys equipment, utilizes the radio, leaves the location, etc. The Geofence functionality can also be dictated by police agency sectors or reporting districts.

Sensors that may be connected via wire, wireless, Bluetooth, WiFi, RFID or other electronic connection means in addition to those discussed include a backup holster (such as provided in the officer's pants pocket) that carries a secondary weapon such as a handgun, a heartbeat sensor in his/her bullet resistant vest or other area worn on the body, a proximity sensor, such as for determining physical contact from a person or object, an accelerometer (for running, fast twisting, or fighting), a heat or fluid or other sensor for measurements such as perspiration and blood pressure, a “level” or position with respect to horizontal sensor to sense a prone officer, and a GPS module. Further, any type of weapon may be provided with a sensor, including a baton, rifle, shotgun, or any other lethal or less lethal type of weapon. For example, a baton may be integrated with an accelerometer so that the system records the speed and force when the baton is used to strike an object. Connection and integration are provided with a CAD, connectivity to smartphone or tablet for meta tagging information, either by the officer or according to an algorithm provided for metatagging purposes, and connectivity to a remote device, such as a device in a police car (seat belt use sensor, crash sensor, back seat detention sensor, code 3 light/siren, and/or playback/review of audio and/or video in the vehicle. Additionally, the CAD or similar device in a police car (or other area) may import relevant CAD metadata into the recorded video/audio from the BWC and/or system. This integrates critical indexable/searchable metadata into the recording, such as call for service, call notes, call disposition, time stamps related to the CAD, police radio transmissions, etc.

The system may also incorporate proximity technology whereby the officer's processor/recorder or BWC is activated when in the proximity of officers equipped with similar technology. Such an activation may be initiated when an officer nearby deploys his/her own items of equipment (e.g. handgun). This proximity sensor may be initiated via wireless communication such as commercial wireless, WiFi, Bluetooth, GPS or any other method known in the art.

The system activates an officer's processor, recorder, BWC, etc. when the officer initiates a Code 3 response in his/her police vehicle to an emergent call for service (the scene of a homicide, for example). Generally an agency limits the number of Code 3 vehicles responding to a given call due to the higher liability in operating a police vehicle which is authorized to circumvent normal traffic laws. Other responding back up units may continue to respond to the same emergent call without using their Code 3 lights or sirens. In such a case, the system activates the processor, recorder, BWC, etc. of all police units responding to the same call for service irrespective of the call for service issued for the vehicle (Code 3 or non-Code 3). This automated activation may be initiated via commercial wireless or other type of wireless method.

The present design may save or conserve power consumption of a BWC or other body worn device by only activating during what are considered to be high risk events, and/or activated during predetermined/established and/or high risk events. Video storage may also only be activated during or subsequent to high risk events or incidents considered high risk events. Streaming of video occurs according to established conditions, such as streaming for a specific amount of time and then stopped, or streaming when the officer is in his/her police car or if manually stopped by the officer or command center.

Previous BWC systems have been limited in scope and capability with limited metadata integrated into the recorded video/audio. As a result the amount of indexable metadata, used to minimize video management efforts and increase efficiency of workflows, is relatively small. Many BWC video management software systems require a great deal of manual management after the fact to retrieve, index and augment recorded video. Many of these systems require a user to add relative indexable metadata to recorded video after the fact. This method is highly ineffective and inefficient as it requires a user to find recorded video footage, review it, tag various points in the video and add metatags encompassing written information, and such manipulation raises accuracy and video veracity issues. As discussed above, current BWC systems require a person to add metadata, creating at least a potential human error factor. However, a more accurate collected metadata is automatically collected metadata, based on set hard triggers and predefined within a system.

The present system adds, without user intervention or input, definable and indexable metadata to or on recorded or live video/audio at the source while in the field. For example, with the present system, the moment an officer deploys his/her handgun, the officer worn BWC is automatically activated, the recording buffer saved and metadata related to the activation (drawing of the handgun) is tagged into the video, potentially with the GPS location and a live alert transmitted to a remote location, such as to an RTCC or command center. In certain instances, the incident may be transmitted to other officers or automobiles in the field, i.e. weapon drawn or shots fired to officers in a designated vicinity, such as within a mile of the occurrence. When the officer deploys his/her handcuffs, or other predefined article of police equipment, the metadata with a date/time is also identified and provided with or integrated into the video without need for officer or other interaction. Alternately, these equipment deployments may be relayed to other/additional entities, such as the RTCC, command center and other officers in live time. These entities may be notified of the officer's initial deployment of an item of equipment (e.g. handgun deployment) with GPS location and any additional equipment deployments encountered (e.g. baton and handcuffs).

Additional metadata can be entered by the officer in the field (on the BWC), in the Mobile Digital Computer (MDC) in the officer's police car, on a tablet, smartphone or any other method. These entries may be made via a wired, tethered or wireless means. Such metadata may be tagged or otherwise indicated as added after the incident, and the person providing the tagging may be identified. As an example, an officer may have heard a sound that is not audible on the recording, and the officer may wish to include a tag about the sound heard (glass breaking) at the time he believed the sound occurred. Information may be simple or complex, and if something simple such as “Glass breaking sound” at the 10:18 p.m. point of the recording, with his/her identification number and an indication that such a tag was applied after the incident. Additional metadata can also be added later, such as after the recorded video and corresponding metadata has been provided to or downloaded to a Department server, computer, cloud storage or other storage medium. The metadata and after-the-fact added metadata creates an indexable and searchable database enabling the identification of trends and/or issues which have arisen or may arise with individual officers or within locations. Additionally, this metadata allows an officer or management to quickly query the system to identify key events or patterns for review. The system creates a capability of automatically alerting a user or reviewer regarding which video he/she should review as well as the pivotal moment in the video where a significant action took place.

Other audio/video footage, such as footage captured by Closed Circuit Television (CCTV), interview room cameras, surveillance, automatic license plate recognition (ALPR), gunshot detection, facial recognition technology, etc., may be integrated into the system, providing more data that can be tracked and searched to create a more comprehensive record of events. Other metadata can be added without user input when defined by parameters set by administrators. For example, CAD call information, including incident type, and the locations of other officers even when their BWCs were not activated, etc. can also be obtained, indexed, and saved with saved audio/video footage. Additional information from other sources such as media, internet, social media, etc. can also be indexed and included in the footage.

The video management software or software integration module provided enables seamless capture, download, and management of audio/video files and associated metadata and creates a mechanism whereby this information can be tracked, indexed, searched and retrieved to identify trends and issues or for evidentiary or administrative purposes. The analytics incorporated into the system enable unprecedented predictive management as it relates to BWCs and other audio/video devices, and a proactive approach to mitigating liability in law enforcement and other fields which has never been available before.

The system may incorporate bulk redaction capability, enabling law enforcement and other high liability agencies to more effectively and efficiently respond to public requests for transparency, such as Freedom of Information Act (FOIA) requests. The bulk-redaction function reviews video/audio files and metadata for purposes of public review so as to shield individual faces and or/license plates and other personal identifying information and therefore enable law enforcement and other entities to increase transparency and public trust by providing non active evidentiary files, without compromising individual rights to privacy. Such blurring may be wholesale blurring (i.e. blurring of all images identifiable as faces or identifiable as license plates) or may be individualized, seeking to blur images having established characteristics (dark shirt, blonde hair, license plate of a red automobile). The system may be configured to redact, remove, or blur any and all text displayed on video to ensure addresses, names of businesses, documents, identification cards, etc. cannot be displayed to unauthorized viewers. The system may also redact or remove all metadata from video/audio provided pursuant to the FOIA. The system may utilize active directory or similar technology in order to integrate, automatically populate and cross index users and managers of the system.

The system may employ particular security features, such as watermarking of images, and prohibiting export or alteration outside the accepted chain of custody, etc. Video and audio may be provided in common formats (mpeg, avi, H.264, etc.) or in a propriety format as may tagging and/or notation, and such information may be provided to the cloud or other acceptable media. Video review and tagging may be controlled; as examples, video may be simultaneously reviewed by multiple officers or persons, video may be time synced, and GPS mapping functionality may be provided and/or integrated. Review of the recorded video and/or corresponding metadata may take place in the field (in the officer's police car or other area) by the officer, other officers in the field, or by appropriate personnel once the recorded video has been downloaded to a storage medium in or integrated into the system. If the system utilizes proprietary video formats, corresponding video player software may be exported along with recorded video for evidentiary purposes.

The system may download, upload, transfer, burn onto a CD, copy, and/or share video and metadata recorded. This system includes various security protocols and procedures allowing sharing of recorded video and data without compromising the integrity or security of such data.

The system may integrate additional external video and metadata, also be indexable and searchable. This additional externally sourced video and metadata includes but is not limited to fixed surveillance cameras (CCTV) recordings, interview room recordings, audio recordings, personal video recorder video and/or audios, photographs, and/or visual and/or audio provided in any other digital medium.

The system may employ advanced analytics for predictive analysis, generating reports, and automatic flagging of key predefined events (e.g. handgun deployed). This allows an agency to be more effective in the deployment of its resources and reduce potential risks. The system generates recorded and/or live video/audio footage with integrated trigger points and metadata identifying the triggers. An officer deploying a baton and subsequently a handgun from his/her belt causes the system to activate a BWC and tag metadata onto the recorded video footage. Metadata in this instance may include but is not limited to date, time, GPS location, officer identifier, movement of the officer, police equipment deployed, duration, additional deployments of other equipment, locations of other officers, etc. This captured information is then utilized to generate a greater understanding of a specific incident or to generate reports and statistical information encompassing numerous incidents, officers, and/or types of events. This information can also be used to generate predictive analytical data to identify trends, patterns and potential issues.

This metadata allows relevant personnel to quickly index and review occurrences of interest without having to search through hours of recorded video. For example, an officer may be deployed in an incident of civil unrest in which his/her BWC is activated before or during the incident. Hours later the officer may be involved in a significant use of force whereby he/she deploys a baton, pepper spray or handcuffs. This officer may continue to record this subsequent event for additional hours. After the subsequent event, the officer, police manager, media, etc. may want to review only the recorded portion of the officer's video in which the force was used. At the time of the recordings or afterward, the system indexes and identifies the officer and what equipment was deployed during this portion of the video. The system may thus index and link the recorded video.

Content of the reports may vary, and in one example include all crimes within a particular area or Geofence, and/or cross-indexed with the number of high risk actions (i.e. arrest, use of force) taken by individual officers. Reports can also be generated based on the types of actions taken by officers and the corresponding arrest statistics, or conversely, the type of crime committed with corresponding officer actions. These crime overlays can be integrated with calls for service in real time in order to more accurately predict crime rates within certain geographical areas, predict officer behavior based on historical patterns, and identify potential training issues based on a comparison of the crime and officer response.

Additionally, the system may also index all 911 calls received by a police law enforcement agency with time, location and other pertinent information. In general numerous 911 calls are generated from various citizens during a single call for service. For example, during a shooting call, thirty (30) separate citizens may call to report the sounds of gunshots in the area. These 911 calls are then consolidated into one call for service, which is subsequently generated and dispatched to appropriate police units, potentially numerous police units, to handle. The system may integrate calls for service as well as all 911 calls as metadata for use in, for example, GPS maps integrated with the video, GPS locations of the officers, and other relevant events. Such functionality provides additional information, such as potential witness identification and potential witness perspectives, relevant to a given incident.

The system identifies patterns based on standards or rules set by users and/or administrators. The present system identifies patterns based on an expansive collection of metadata cross referenced with individual officers and their actions and baseline standards. For example, system administrators may choose to require an automatic flag upon a certain number of handgun deployments within a given period of time to assess factors such as timeliness, appropriateness, and resultant officer response. Pattern identification may also be employed to track the number of arrests, cross-indexed with calls for service, officer GPS locations and officer actions based on deployed equipment within a given area to more effectively predict areas in which higher levels of certain types of crimes occur, therefore enabling a more strategic deployment of officer resources. The automated pattern identification can be set to flag any number of incidents based on recorded metadata, including the number of detentions versus arrests. The system may rely on data from various sensors, such as seat sensors in the back of a patrol car triggered by pressure, motion, or proximity, or the use of handcuffs without subsequent arrest in order to capture a more comprehensive collection of data.

In law enforcement today, data may be particularly beneficial in situations which persons are detained in the back seat of police cars as differentiated from being arrested. The system employs sensors in the back seat of a police car triggered by motion, pressure, proximity, etc. to tag when a person has been detained. If handcuffs are deployed this will also be tagged. If a person is subsequently arrested and booked for a crime, the system distinguishes the situation as an arrest versus a person in the back seat of a police car or handcuffs deployed without a corresponding arrest statistic. Conversely, if an officer deploys handcuffs and detains a person at a location away from his/her police car (in a home for example), the system tracks that an officer's handcuffs were deployed outside of the police station or police car (via Geofencing or other method) but that an arrest report/booking was not generated. The system flags this incident as a potential detention. Recurrent patterns are identified and automatically flagged for police managers.

The system may provide alerts to dispatch centers or supervisors in order to advise management personnel of the deployment of high risk pieces of equipment, including, but not limited to, handguns, batons, pepper spray or other less lethal weapons. The system may provide notifications of equipment deployment, and may subsequently alert appropriate managers of an arrest, use of force, or deployment of equipment even if the equipment is not used. Based upon patterns identified, system rules may be set up to require an alert each time an officer enters a particular geographical area or Geofence, for example an area of increased criminal activity or a particular address which has a history of excessive complaints against officers. Training needs of officers may be provided based on results of patterns identified via the system. Any alert may be triggered by any predefined rule, pattern, anomaly, etc., with ongoing efforts to more effectively manage scenarios in real time.

The system may also operate with existing reporting functions and improve workflow and minimize delays. As data is recorded and downloaded to department servers, the system may initiate a reporting function that fills out predefined and possibly preexisting forms or data fields with and/or using appropriate metadata. For example, upon the recording of an incident, the system may enter data into specified form fields of a police report. The system may generate individual officer timelines coupled with GPS mapping technology, call for service, and a detailed timeline of police equipment deployed tagged with corresponding video to potentially increase the accuracy of police reports, reduce workload, create cross-indexed documentation, identify possible training issues, identify officers who are falsely reporting their activities, etc. These individual officer timelines may include other data such as a GPS map overlay, photos, reports, calls for service information, etc. Timelines may also be generated to collectively reflect all relevant officers on specific call, and/or all officers on a shift or over a larger time period.

The current system therefore generates reports or creates reporting that may potentially include geographic information (information relating to Geofenced areas, officer location, sectors or reporting districts, incidents or data encompassing surround agencies, etc.), by shift, officer, unit, date, time, etc., including the types of actions by officers (handgun, baton, etc. deployed, arrest information and stats, GPS location), information from other sensors (gunshot detection, proximity detection, etc.), with crime overlays to index crimes versus officer actions. Such reports and reporting may encompass calls for service, including live calls and/or historical information on calls (ten calls from this zone in the last month), and cross referencing with locations of all relevant (e.g. 911) calls. Such cross referencing may include calls made during significant events, shootings heard in the area, etc. In practice, a single call for service may be generated even though numerous different callers dial 911 from different locations about the same incident. This provides geographic indexing or large scale or significant events.

The present system seeks to identify patterns based on the officer's GPS location, the officer's location versus police vehicle location, the deployment of equipment (handgun, baton, OC spray, handcuffs, use of radio, electroshock weapon such as a Taser X26P, collapsible baton, emergency radio trigger activation, ammunition pouch, manual activation of recording device), actions of the officer that are discernable, location of the officer during a civil unrest incident, and so forth. Once an officer's location and the deployment of equipment is identified, for example, when a baton is deployed during a civil unrest incident, the system can determine where more police resources are needed and reporting by the system may occur at, for example, a command center or RTCC.

The reporting may further include state of external sensors including but not limited to gunshot detection sensors, backseat detention detectors, rifle/shotgun/less lethal deployment sensors, proximity sensors of officer or other officers, traffic collision sensors, police radio interface (the emergency radio trigger), and/or a command center alert override switch, as well as diagnostic self-check functionality, reporting issues with the sensors. Reporting may also include excessive deployment of weapons, use of handcuffs with no arrest, and other relevant events.

The duty belt as described above is embedded with various sensors to provide information to a processor and BWC. The duty belt receptacles which carry or contain various police equipment such as a handgun, baton, pepper spray, radio, etc. generally have a retention system, strap, button, clasp or other similar device to ensure the item is retained in the receptacle until it is intended to be deployed. The system tracks and automatically identifies that a receptacle's retention system has been unsnapped, unbuttoned, etc. versus the situation where an item in the receptacle has been deployed. An alert may be generated and sent to a command center or RTCC. Such alerting is significant when, for example, an officer is involved in a fight with a suspect over his/her handgun. In such a case, the suspect may defeat the holster retention system (thereby activating the BWC and sending a distress signal with GPS location to a command center resulting from the holster connection being defeated) but the officer will continue to attempt to keep the handgun inside the holster during the altercation. In this case, backup officers can be dispatched to the altercation location even though the officer's handgun has not been removed from the holster.

The system may further employ a processor/video camera on the officer's person having the capability of video/audio recording events upon activation and transmitting vital metadata regarding the officer's actions, GPS location and streaming live video to a police command center or RTCC. The transmission of video and metadata to the remote location may be via commercial wireless (cellular), WiFi, Bluetooth, wired or any other means. The system may exclusively transmit metadata to a RTCC or command center indicating the GPS location and equipment deployed. The system may be configured so that remote users, RTCC or command centers can, in real time, activate the streaming function of BWCs worn by officers in order to obtain a greater real world sense of what is occurring during a given incident.

Additionally, the system may be configured so that some actions based on certain factors (such as a call for service, equipment deployed, etc.) activate the officer's BWC and stream a given time period of video to a remote user, RTCC or command center, thus limiting bandwidth requirements. For example, if an officer responds to a shooting call deploys his/her handgun, the system may active and stream video to the RTCC or command center for a predefined amount of time to allow responding units and mangers a more comprehensive understanding of what is occurring and the resources required. In the case of an officer's system detecting a gunshot and the subsequent deployment of the officer's handgun, the system may be configured to activate and stream live video with a GPS location to the command center or RTCC and continue streaming such video until the system is manually or remotely deactivated. The system can be configured to receive and transmit video and audio in various ways and not limited to the scenarios described above. The system activates the processor/recorder when the officer is involved in high liability activities (arrest, force, shooting, etc.), allowing the officer to record only the most relevant events versus all events.

The system may have a diagnostic self-check in the duty belt, integrated as part of the system. This self-check may automatically or manually sense the status of the system, query each associated receptacle and other relevant devices via a wired or wireless connection and document/record the state(s) on an ongoing basis. If an anomaly is detected whereby there is a faulty sensor, retention system or battery issue, or wireless connectivity issue or other irregularity, the system may notify the user and/or command center and document/record this anomaly. The diagnostic self-check may initiate when the system is first activated and on a continuous ongoing basis if desired.

As described above, the duty belt may have sensors integrated into various receptacles and other areas, which provide more accurate metadata in terms of a safety retention system being defeated versus an item being deployed. If a sensor fails or is damaged, a second corresponding sensor in the receptacle continues to function and activates the processor, BWC and/or alerts the command center. The system detects that only one sensor worked and records or documents a potential failure of the sensor in the receptacle. For example, if a holster contains a sensor in the safety strap retention device to detect the safety strap being deactivated and a sensor in the body of the holster to detect if the handgun is withdrawn, the system can distinguish the difference and the relevant failure. In this case a handgun cannot be withdrawn for a holster unless both the safety retention strap is deactivated and the handgun is withdrawn from the holster. This provides redundancies in the recording and activations of the system as well as identification of sensors or receptacles which may be malfunctioning.

The system may therefore actively monitor malfunctions or issues within the system. The system employs diagnostics and self-checking in all aspects of the system, including the BWC, the duty belt activation system, the integration of wired and wireless ancillary devices such as shotgun or rifle, the officer's police vehicle, integration and connectivity with a command center or RTCC, integration with the system which downloads and manages this information, etc. and related systems, subsystems, and processes.

One method to accomplish the “system check” is a method similar to a Packet Internet Groper (PING) in which an active signal is sent out to various sensors and systems and a reply signal or PING is received if the system is operational. This method allows the system to actively inquire and monitor its state to ensure all processes and capabilities are operational. If a PING (or similar method) is not received or the system senses as issue, the system may notify an administrator, user or other entity regarding the issue so that the issue may be addressed. Additionally, this capability provides critical information that addresses an issue whereby a malfunctioning sensor, for example, does not activate a BWC integrated into a duty belt and fails to record a critical incident. The system may sense and record information demonstrating that the officer attempted to active the BWC, but the malfunction prevented an activation. Selected components may provide dual redundancy. The system will be aware of items carried and/or deployed as well as their current state and such information may be monitored or tracked and recorded, such as by application of metadata to a recording. This function enables other officers and the RTCC or command center to be aware of all law enforcement tools carried by officers in the field and better allow their deployment in case of a significant event requiring use.

The system also provides management alerts, in various instances including but not limited to deployment of a handgun, baton, handcuffs, when an officer enters a Geofence around a predefined area (such as a house which has a history of excessive complaints against officers), etc. Predictive alerts can also be provided, such as excessive deployment of handguns, i.e. 25% above the baseline level or above an average level, identifying “problem” officers, enhanced tracking of previously identified “problem” officers, and general crime trends based on officer actions coupled with crime analysis and calls for service. The system may actively track “problem” officers so that all high risk incidents are automatically flagged and transmitted to a supervisor of a given officer for immediate review. These “problem” officers may have been identified as having an inordinate number of uses of force, complaints, or for other reasons.

The system also may be configured to integrate with complaints which have been lodged by citizens or other entities regarding law enforcement policies or actions by individual officers. When a complaint is filed, this information is electronically noted and integrated into the system. The system may then query information related to the complaint or generate a report in which patterns of behavior are identified by individual officers, shifts of officers, police agencies as a whole, etc. These patterns could be used to predict potential future behaviors or issues which the police agency or other entities could use to prevent occurrences from transpiring in the first place. This process may be automated or manual in nature. The system would analyze metadata and other information to create norms and identify deviations from these norms.

The present system fills out prospective key areas of police reports, fills documents such as “check off sheets” with equipment deployed, generates an individual officer timeline coupled with GPS map and call for service info, and as noted can identify or be used to identify potential training issues as well as other attributes noted in this document. For example, the system can identify equipment being deployed too soon, not deployed soon enough, or use of improper equipment for a given situation. Again, reports may be generated on all of the foregoing and analytics made available. The system has the capability of automating use of force reporting which traditionally relied upon the individual officer to identify a use of force and notify a supervisor so that an administrative investigation could be conducted to document the occurrence. The system provides the ability to record a use of force and/or arrest and the events preceding the situation via a recording buffer as noted above. The system then tags all automated triggers, GPS location and other relevant information into the recorded video. Additionally, the system may transmit an alert to other officers, supervisors, a command center and RTCC that an officer had deployed a tool from his/her duty belt. This video and information automatically collected are then provided to other components within the system, automating use of force reporting in real time for review and potential inclusion in subsequent police reports.

A dramatic increase in available technology in recent years has enabled local law enforcement to create Real Time Crime Centers (RTCCs) through which historical and live data can be accessed by or provided to law enforcement officers in real time, rather than waiting for weeks as had been the normal practice and remains normal practice in many jurisdictions today. Real Time Crime Centers (RTCC) are central hubs of information, run by civilian and sworn personnel, where live information, news reports, calls for service, crime trends, comprehensive databases and criminal files are accessible in moments and data is in many instances relayed to individual officers in minutes or less. RTCCs have allowed law enforcement agencies to shift from a reactive mindset to a proactive one, supporting the mitigation of criminal activity and better preparing officers for what they will encounter.

RTCCs incorporate satellite imagine and mapping technology to depict real time allocation of law enforcement resources in local jurisdictions, providing the ability to strategically deploy personnel in key areas. RTCCs are able to provide law enforcement officers with information that may become critical such as suspect information and criminal status, location history and other historical information as they are en route to calls for service, pushing the data straight to their in-car computers (MDCs), thereby better preparing the officers and providing them with historical data which may become useful, potentially altering their approach to a call and increasing their safety.

Currently, RTCCs utilize data as described above and rely on a limited amount of live data to identify what officers in the field are doing. The data currently generated by officers in real time is generally the GPS location of the officer's police car, police radio transmissions, and current status, monitored via the computer aided dispatch (CAD) systems. This method is extremely inefficient and does not provide an overall sense of actual officer actions in the field due to the large number of officers needing to be monitored and the inability of the RTCC to understand what is occurring during chaotic calls for service such as an officer involved shooting. The system provides the ability for the RTCC to understand exactly what an officer is doing in real time, automatically with indexable data points when the officer is involved in high-risk actions such as deploying a handgun. The system allows an RTCC to quickly determine the locations of all officers, integrated into a map with all calls for service or other police concerns while identifying in real time the police equipment officers have deployed. This capability provides the ability to understand where police resources need to be redeployed, where officers are in need of assistance and the level of supervision required.

The ability to provide intelligence to line level personnel in real time can tremendously improve officer safety and reduce the officer and detective man-hours required to solve a crime. The present system integrates into existing RTCCs, providing real time management of unfolding scenarios, deployment of assistance and additional resources in critical incidents before officers even have to make a request, and access to metadata that may help to better prepare officers for what they may encounter during calls for service. The system pushes real time video from the field to RTCCs based on predefined triggers and rules, enabling real time supervisory direction even when a supervisor may not be on scene. The live videos managed through the system pushed to RTCCs include critical and situation specific metadata including exact GPS location, shots fired, weapons deployed, and so forth, enabling agencies to see exactly where the individual officer is, even away from their vehicle, and provide assistance to officers as quickly as possible.

The present system thus enables real time notification when a critical event occurs, such as police equipment being deployed. Simply knowing an officer's location, locations of all calls for service and the equipment an officer is deploying in real time provides advantages over current RTCC capabilities. In addition to live notifications of these events and incidents, RTCCs have access to files recorded, collected, or managed by the system on an as-needed or as permitted basis, and therefore will have immediate access to data history, including for specific incidents, locations, and/or officers. Crime analysts are better able to predict types of high risk incidents that may occur in areas within their jurisdiction and dispatchers will be better equipped to send immediate assistance to officers based on the needs of the scenario. Supervisors are notified of trends which have been flagged are therefore be better equipped to identify problem officers, training needs and emerging trends and issues in order to more effectively institute training programs.

The system tracks and may identify patterns of behavior, tactics and other definable metrics related to officer performance. The system may generate a report, flags, alerts, etc. to identify training trends which need to be addressed as well as potential individual or groups of officers who may be in the most need of training. These trends may be identified by collected metadata coupled with subjective assessment by supervisors.

The RTCC, command center or remote user (such as police watch commander) can remotely activate or turn off an officer's processors, recorder or BWC, allowing the system to automatically stream live video to the RTCC, command center, or remote user. Such a capability is dictated by rules and settings provided to or within the system.

The system may utilize a graphical user interface (GUI) or other appropriate functionality such that live and recorded video from officer belt systems, fixed CCTV, in-car-video systems, etc. are displayed on a computer screen. The computer screen may have one or more video streams displayed at any given time with the ability to time synchronize the video streams. The videos may include but not be limited to BWC video, Taser X26 camera videos, videos from other sources, etc. The same screen may also integrate a live or recorded GPS map displaying all officers, police vehicles and other relevant GPS data simultaneously which is cross-indexed with the recorded or live video. The system may also dedicate a portion of the screen to relevant metadata time stamped and identified. For example, the GUI may display a GPS map of three (3) officers in their police vehicles responding to a call for service (gunshots heard). The system also displays the GPS location of the call, 911 callers and other relevant GPS information such as responding medical services. The system denotes the speed, direction and manner in which officer vehicles are responding (normal driving versus Code 3 with lights and siren). The system may be integrated with the Computer Aided Dispatch (CAD), and relevant information of the call for service may be displayed. Where appropriate, the system shows which officers are recording video/audio via their BWC and duty belt, and the system may stream the video to a command center in real time. Upon arrival to the call for service, the system may show the locations of the officers walking to the target location and location of their respective vehicles parked nearby. The system may display the officer's locations and denote tools being deployed such as a handgun, emergency radio trigger, handcuffs, etc. A timeline bar can be provided on the screen with trigger points denoted on the timeline bar, permitting a viewer to quickly see and understand indexes for key events occurring in the recorded video. The system may display all of this information in a consolidated format, and such information and GUI may be preserved and made available (and indexed) for evaluations, queries and analysis after the fact. The system may integrate or work in tandem with existing video management software (VMS), databases, management tracking software, etc.

The system may push software and capability updates to recorder, processors, BWCs, smartphone type devices, etc. These software updates may be provided via wired, tethered, docked, wireless or any other connection. This capability allows the system to update software and capabilities with little interaction with the end user officer.

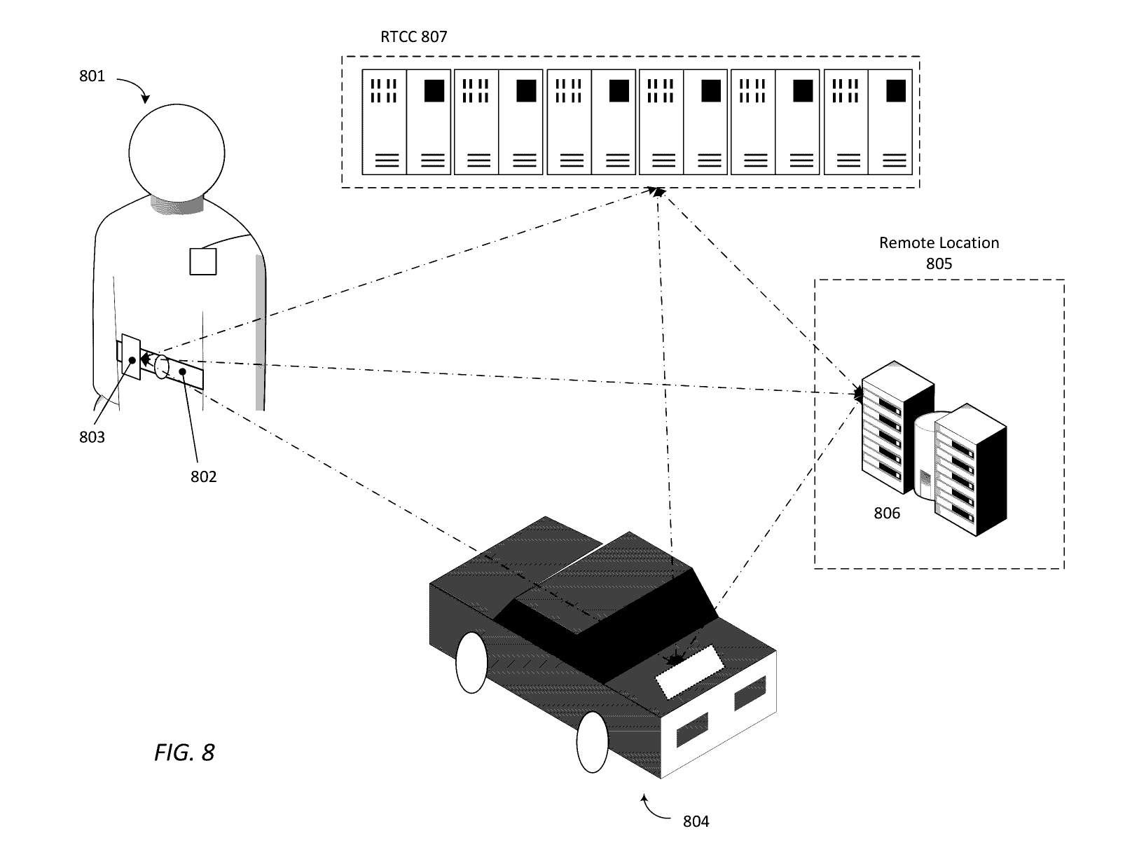

FIG. 8 represents a general overview of the entire system and various components within the system. Officer 801 is wearing a belt 802 equipped as described herein as well as a video recording device 803, and the recording device 803 may record information, receive video and/or audio such as via hard wire from a video recording device provided with the officer 801, and the recording device may apply metatags or other information to recorded media as appropriate. Recording device 803 may transmit information to remote locations, including patrol car 804 or remote location 805, which may in one instance be a police station. Additionally or alternately, data may be collected at data collection location 806, which may be at a police station or other location. In FIG. 8, the collection location 806 is shown in the remote location 805, but these may be separate. Data may be collected in real time or near real time, or may be collected at the end of the officer's shift, or in any other reasonable manner, such as when the officer is within a certain range of an acceptable upload receiver, e.g. a receiver connected to a computing system.

Transmission from the recording device 803 to collection location 806 may be via an active connection, such as cellular, WiFi, wired, or any other media connection, and collection location 806 may have access to video, audio, and related information, i.e. metadata, on a live or near live basis. Collection location 806 may provide the information to appropriate devices and/or personnel, including dispatchers, administrators, supervisors, and remote locations such as RTCC 807. RTCC 807 or collection location 806 may collect data from various officers in the field and may analyze the data according to established rules and parameters, and certain functionality may be triggered at or by the RTCC 807 or collection location 806, which again may be located at a police station, local control center, or other location. For example, if the sounds of shots fired are received at a recording device such as recording device 803 with the officers at the location not having drawn a firearm, this may cause the RTCC 807 or the collection center to transmit an alert that all officers in the area are to travel to the GPS location of the device that received the sounds of shots fired. Alternately, should an officer be “down” (injured or killed) as sensed by a “level” sensor, additional officers may be dispatched to the location. Should an officer have requested backup before entering a location and subsequently have deployed handcuffs several minutes after entering a location with no other weapons drawn or events sensed, excess backup units may be called off. Information may also be provided from the RTCC 807 or collection location 806 to a patrol car 804 or to the recording device 803. In this manner, scores of police officers may be managed from a central location based on up-to-the minute information collected in the field.

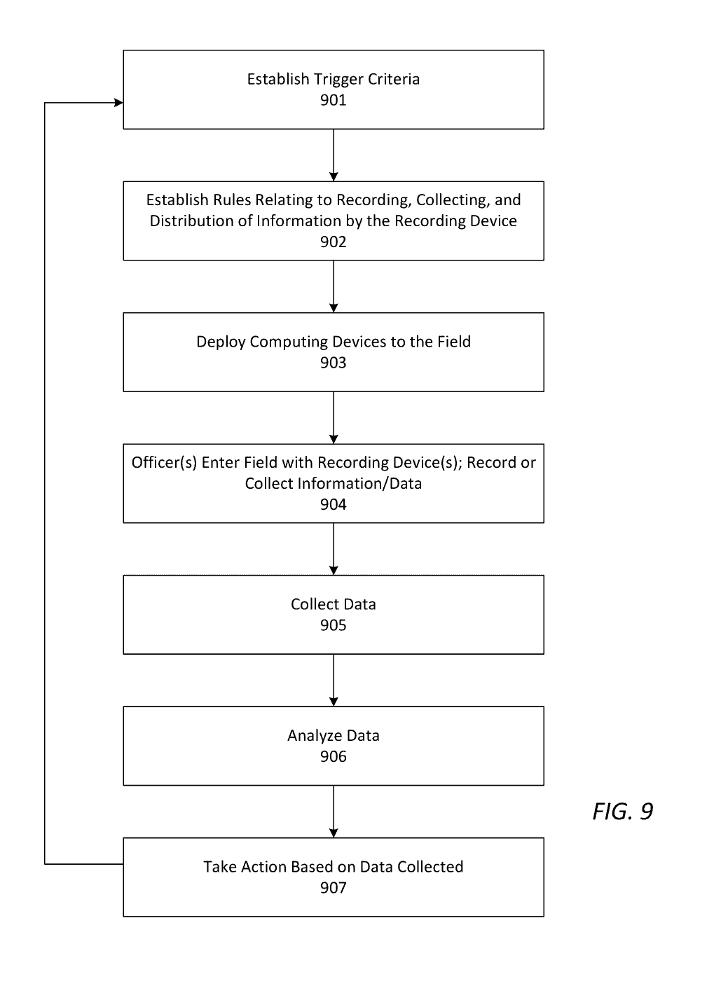

A general flowchart of overall operation of the system is provided in FIG. 9. Point 901 calls for establishing trigger criteria, i.e. events that will trigger entry of metadata to a recorded incident (deployment of weapon, other belt interactions, sensor data above a threshold, etc.) Point 902 establishes rules relating to the recording, collecting, and distribution of information by the recording device, such as applying metadata in certain instances, transmitting alerts, prohibiting erasure, allowing metadata application after the recorded incident, conditions for downloading, and so forth. Both the rules established at point 902 and the trigger criteria at point 901 may apply to multiple devices and may be entered at a central location or more than one location. For example, the chief of station X may wish to prohibit entry of metadata by an officer while the chief of station Y may allow such entry under certain circumstances, and this may be established at computing devices located at stations X and Y, or may be provided at an RTCC for officers reporting to both stations.

Point 903 deploys the computing devices to the field, such as in belts worn by officers. At point 904, the officers enter the field and receive orders and may record or collect information according to the triggers encountered and rules established. Data is collected at point 905, where data collection can be at the control device on the belt worn by the officer, and/or at a remote location (police car computing device, station house computing device, RTCC), at the time it is received and transmitted or after the data has been collected. At point 906, data may be analyzed, and at point 907, data may be employed to take action, such as deploy officers, provide reports, send out notifications to other computing devices or particular officers, and so forth. In this manner, data is received, recorded, collected, analyzed, and personnel and resources deployed in an efficient manner. A loop back from point 907 to 901 is shown in FIG. 9 to indicate the various points or attributes of the system may be changed depending on desires and circumstances, i.e. monitoring one type of indication or event may become unnecessary, new sensors may be deployed in the field, certain new rules may be established and old rules rendered unnecessary, and so forth. In essence, all aspects of FIG. 9 may be updated at any time and/or all times, and the loop from point 907 to 901 is intended to indicate the system may be constantly evolving.

The present design includes and encompasses software such as, but not limited to, integration, analysis, data management, triggering, detection, execution, etc. for the police duty belt described herein and similar or ancillary systems or subsystems. Additionally, the design encompasses software related to the integration, triggering, metadata and augmentation of existing or new BWCs, other ancillary sensors, devices, etc., (such as gunshot detection police cars, rifles, etc.) and advanced reporting functionalities. The system also encompasses software related to video management, analysis, predictive analysis, accountability, alerts, flagging, tagging, routing, security, notifications, data integrity, user/admin management, etc., as well as software related to video storage and management, integration with police command centers, Real Time Crime Centers and other systems. The software is provided in or with BWCs or other video/audio recording devices, other related and/or ancillary devices that provide information (gunshot detection, police car, etc.), the police belt system provided herein, and software and/or hardware is provided that includes a video management system that manages video and/or audio collected by the various officers in the field and/or other relevant video and/or audio, predictive accountability and management functions, reporting and advanced reporting functions such as analysis and reporting, and RTCC functionality.

Thus according to the present design, there is provided a system for effectively utilizing law enforcement resources, comprising a recording device configured to continuously record audio and/or video, thereby providing an audio and/or video recording, a computing device associated with the recording device, the computing device configured to receive a trigger indication and upon receiving the trigger indication establish a prior point in time of the audio and/or video recording as a beginning of a critical event and preserve recorded audio and/or video from the beginning of the critical event to an end recording point, and a remote device configured to analyze audio and/or video recordings including the preserved audio and/or video and provide information based on audio and/or video recording analysis. The remote device is additionally configured to create predictive analysis reports and alerts for key events and officer behaviors. At least one of the computing device and the remote device is configured to apply information to the recorded audio and/or video based on events occurring between the beginning of the critical event and the end recording point for analysis by the remote device.

According to an alternate version of the present design, there is provided a system for deploying law enforcement resources, comprising a recording device configured to continuously record audio and/or video, thereby providing an audio and/or video recording, a computing device associated with the recording device, the computing device configured to establish a prior point in time of the audio and/or video recording as a beginning of a critical event and preserve recorded audio and/or video from the beginning of the critical event to an end recording point, and a remote device configured to analyze audio and/or video recordings including the preserved audio and/or video and provide information based on audio and/or video recording analysis. The computing device is configured to sense a trigger indication using multiple sensing means and issue a command to the recording device upon sensing the trigger indication.

According to a further version of the present design, there is provided a system for deploying law enforcement resources, comprising a recording device configured to continuously record audio and/or video, thereby providing an audio and/or video recording, a computing device configured to transmit a trigger indication signal to the recording device to commence recording and receive the audio and/or video recording by establishing a prior point in time of the audio and/or video recording as a beginning of a critical event and preserve recorded audio and/or video from the beginning of the critical event to an end recording point, and a remote device configured to analyze the preserved audio and/or video and provide information based on audio and/or video recording analysis. The computing device is configured to sense a trigger indication using multiple sensing means and transmit the trigger indication signal to the recording device upon sensing the trigger indication.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A system for effectively utilizing law enforcement resources, comprising:
a recording device configured to continuously record audio and/or video, thereby providing an audio and/or video recording;
a computing device associated with the recording device, the computing device configured to receive a trigger indication and upon receiving the trigger indication establish a prior point in time of the audio and/or video recording as a beginning of a critical event and preserve recorded audio and/or video from the beginning of the critical event to an end recording point; and
a remote device configured to analyze audio and/or video recordings including the preserved audio and/or video and provide information based on audio and/or video recording analysis;
wherein at least one of the computing device and the remote device is configured to apply information to the recorded audio and/or video based on events occurring between the beginning of the critical event and the end recording point for analysis by the remote device.

2. The system of claim 1, wherein computing device includes an override feature engageable by a wearer to override the trigger indication and inhibit the trigger indication from establishing the critical event.

3. The system of claim 1, wherein the computing device includes a vibratory alert function configured to notify a wearer that the computing device has been activated and is recording.

4. The system of claim 1, wherein the computing device comprises a feature to deactivate trigger indications when a wearer is in a defined geographic location.

5. The system of claim 1, wherein the computing device includes an acoustic sensor and the computing device is configured to provide a trigger indication based on sounds sensed by the acoustic sensor.

6. The system of claim 1, wherein the computing device is configured to inhibit a person from altering recorded information maintained on the computing device.

7. A system for deploying law enforcement resources, comprising:
a recording device configured to continuously record audio and/or video, thereby providing an audio and/or video recording;
a computing device associated with the recording device, the computing device configured to establish a prior point in time of the audio and/or video recording as a beginning of a critical event and preserve recorded audio and/or video from the beginning of the critical event to an end recording point; and
a remote device configured to analyze audio and/or video recordings including the preserved audio and/or video and provide information based on audio and/or video recording analysis;
wherein the computing device is configured to sense a trigger indication using multiple sensing means and issue a command to the recording device upon sensing the trigger indication.

8. The system of claim 7, wherein computing device includes an override feature engageable by a wearer to override the trigger indication and inhibit the trigger indication from initiating recording using the recording device.

9. The system of claim 7, wherein the computing device includes a vibratory alert function configured to notify a wearer that the computing device has been activated and is recording.

10. The system of claim 7, wherein the computing device comprises a feature to deactivate trigger indications when a wearer is in a defined geographic location.

11. The system of claim 7, wherein the computing device includes an acoustic sensor and the computing device is configured to provide the trigger indication based on sounds sensed by the acoustic sensor.

12. The system of claim 1, wherein the computing device includes a function inhibiting a person from altering recorded information maintained on the computing device.

13. A system for deploying law enforcement resources, comprising:
a recording device configured to continuously record audio and/or video, thereby providing an audio and/or video recording;
a computing device configured to transmit a trigger indication signal to the recording device to commence recording and receive the audio and/or video recording by establishing a prior point in time of the audio and/or video recording as a beginning of a critical event and preserve recorded audio and/or video from the beginning of the critical event to an end recording point; and
a remote device configured to analyze the preserved audio and/or video and provide information based on audio and/or video recording analysis;
wherein the computing device is configured to sense a trigger indication using multiple sensing means and transmit the trigger indication signal to the recording device upon sensing the trigger indication.

14. The system of claim 13, wherein computing device includes an override feature engageable by a wearer to override the trigger indication and inhibit transmission of the trigger indication signal.

15. The system of claim 13, wherein the computing device includes a vibratory alert function configured to notify a wearer that the computing device has been activated and is recording.

16. The system of claim 13, wherein the computing device comprises a feature to deactivate trigger indication signal transmission when a wearer is in a defined geographic location.

17. The system of claim 7, wherein the computing device includes an acoustic sensor and the computing device is configured to provide the trigger indication signal based on sounds sensed by the acoustic sensor.

18. The system of claim 1, wherein the computing device includes a function inhibiting a person from altering recorded information maintained on the computing device.
